(19) United States
(12) Patent Application Publication
(10) Pub. No.: US 2010/0198415 A1
(43) Pub. Date: Aug. 5, 2010

(54) AIR-CONDITIONING APPARATUS

(75) Inventors: Satoshi Kawano, Osaka (JP); Masahiro Oka, Osaka (JP); Kazuhiko Tani, Osaka (JP); Atsushi Okamoto, Osaka (JP)

Correspondence Address: GLOBAL IP COUNSELORS, LLP, 1233 20TH STREET, NW, SUITE 700, WASHINGTON, DC, 20036-2680, US

(73) Assignee: DAIKIN INDUSTRIES, LTD., Osaka-shi, Osaka (JP)

(21) Appl. No.: 12/601,708

(22) PCT Filed: May 27, 2008
(86) PCT No.: PCT/JP2008/059686

§ 371 Date: Nov. 24, 2009

(30) Foreign Application Priority Data
May 30, 2007 (JP) 2007-143815
May 20, 2008 (JP) 2008-131874

(51) Int. Cl. G05D 7/00; F25B 27/00; F25B 41/00; F25B 49/00

(52) U.S. Cl. 700/282; 62/238.6; 62/513; 62/228.1

(57) ABSTRACT

An air-conditioning apparatus includes first and second outdoor units having first and second outdoor heat exchangers and first and second heat source-side degree of subcooling adjustment devices configured to adjust first and second degrees of subcooling in outlet sides of the first and second outdoor heat exchangers, respectively. First and second outdoor-side determination units are configured to determine first and second degrees of subcooling, respectively. A controller is configured to control the first and second heat source-side degree of subcooling adjustment devices, respectively, such that a difference between the first degree of subcooling and the second degree of subcooling is reduced when refrigerant is charged into a refrigerant circuit having the first outdoor heat exchanger and the second outdoor heat exchanger.

### TECHNICAL FIELD

The present invention relates to an air-conditioning apparatus comprising a plurality of heat source units.

### BACKGROUND ART

In conventional practice, there are air-conditioning apparatuses comprising a heat source unit, a usage unit, and a communication pipe for connecting the heat source unit and the usage unit. With this type of air-conditioning apparatus, a method is used in which the heat source unit is charged in advance with a predetermined amount of refrigerant, and when the apparatus is installed on site, it is charged with an additional amount of refrigerant according to the length of the communication pipe connecting the heat source unit and the usage unit. However, since the length of the refrigerant pipe differs depending on the conditions of installing the air-conditioning apparatus at the installation site, there have been cases in which it is difficult to charge the refrigerant circuit with an appropriate amount of refrigerant.

In view of this, an operation has been proposed in which, when the refrigerant circuit is additionally charged with refrigerant, the amount thereof is determined according to the degree of subcooling of the refrigerant in the outlet of a heat source-side heat exchanger functioning as a condenser while the usage unit is set to the cooling operation, and the refrigerant continues to be charged until the degree of subcooling reaches a predetermined value (Patent Document 1, for example).

<Patent Document 1>Japanese Laid-open Patent Application No. 2006-23072

### DISCLOSURE OF THE INVENTION

### Technical Problem

However, in an air-conditioning apparatus comprising a plurality of heat source units, when the refrigerant circuit is charged with the refrigerant, there are occasions in which the refrigerant drifts due to the installment conditions of the heat source units, the temperature conditions, and other conditions; and the degrees of subcooling in the outlets of the heat source-side heat exchangers become disproportionate. Therefore, when the amount of refrigerant charged in the refrigerant circuit is determined according to the degrees of subcooling of the refrigerant in the outlets of the heat source-side heat exchangers, there is a danger of reducing the accuracy of this determined.

An object of the present invention is to improve the precision of determining the amount of refrigerant charged in the refrigerant circuit when the refrigerant circuit is charged with refrigerant in an air-conditioning apparatus comprising a plurality of heat source units.

### Solution to Problem

An air-conditioning apparatus according to a first aspect of the present invention comprises a first heat source unit, a second heat source unit, a first determination unit, a second determination unit, and a controller. The first heat source unit includes a first heat source-side heat exchanger and first heat source-side degree of subcooling adjustment means. The first heat source-side heat exchanger functions at least as a condenser, and the first heat source-side degree of subcooling adjustment means adjusts a first degree of subcooling in an outlet side of the first heat source-side heat exchanger. The second heat source unit includes a second heat source-side heat exchanger and second heat source-side degree of subcooling adjustment means. The second heat source-side heat exchanger functions at least as a condenser, and the second heat source-side degree of subcooling adjustment means adjusts a second degree of subcooling in an outlet side of the second heat source-side heat exchanger. The first determination unit determines the first degree of subcooling. The second determination unit determines the second degree of subcooling. The controller controls the first heat source-side degree of subcooling adjustment means and the second heat source-side degree of subcooling adjustment means so as to reduce the difference between the first degree of subcooling and the second degree of subcooling when refrigerant is charged into a refrigerant circuit having the first heat source-side heat exchanger and the second heat source-side heat exchanger.

The air-conditioning apparatus according to the first aspect comprises a controller for controlling the first heat source-side degree of subcooling adjustment means and the second heat source-side degree of subcooling adjustment means. The controller controls the first heat source-side degree of subcooling adjustment means and the second heat source-side degree of subcooling adjustment means so as to reduce the difference between the first degree of subcooling and the second degree of subcooling. For example, in cases in which the amount of refrigerant flowing through the first heat source-side heat exchanger is adjusted by the first heat source-side degree of subcooling adjustment means and the amount of refrigerant flowing through the second heat source-side heat exchanger is adjusted by the second heat source-side degree of subcooling adjustment means, the controller controls the first heat source-side degree of subcooling adjustment means and the second heat source-side degree of subcooling adjustment means so as to reduce the difference between the amount of refrigerant flowing through the first heat source-side heat exchanger and the amount of refrigerant flowing through the second heat source-side heat exchanger. Therefore, it is possible to inhibit refrigerant drift in the first heat source-side heat exchanger and the second heat source-side heat exchanger.

It is thereby possible to improve the precision of determining the amount of refrigerant charged into the refrigerant circuit when refrigerant is charged into the refrigerant circuit.

The reduction in the difference between the first degree of subcooling and second degree of subcooling referred to herein may refer to cases in which the difference between the first degree of subcooling and second degree of subcooling is equal to or less than a predetermined value, as well as cases in which the first degree of subcooling and the second degree of subcooling coincide.

The air-conditioning apparatus according to a second aspect of the present invention is the air-conditioning apparatus according to the first aspect, further comprising a first temperature sensor and a second temperature sensor. The first temperature sensor detects the temperature of refrigerant in the first heat source unit. The second temperature sensor detects the temperature of refrigerant in the second heat source unit. The first determination unit determines the first degree of subcooling on the basis of the temperature detected by the first temperature sensor. The second determination unit determines the second degree of subcooling on the basis of the temperature detected by the second temperature sensor. Therefore, the first determination unit and the second determination unit can calculate the first degree of subcooling and the second degree of subcooling from the temperature of the flowing refrigerant.

In the air-conditioning apparatus according to the second aspect, it is thereby possible to determine the degree of subcooling by a simple configuration.

The air-conditioning apparatus according to a third aspect of the present invention is the air-conditioning apparatus according to the first or second aspect, wherein the first heat source-side degree of subcooling adjustment means is a first heat source-side flow rate adjustment valve, and the second heat source-side degree of subcooling adjustment means is a second heat source-side flow rate adjustment valve. The controller sets the first heat source-side flow rate adjustment valve to a first opening degree and sets the opening degree of the second heat source-side flow rate adjustment valve to a second opening degree having a smaller opening than the first opening degree when the first degree of subcooling is greater than the second degree of subcooling.

In the air-conditioning apparatus according to the third aspect, the controller adjusts the opening degrees of the first heat source-side flow rate adjustment valve and the second heat source-side flow rate adjustment valve on the basis of the first degree of subcooling and the second degree of subcooling. For example, in cases in which the first degree of subcooling is greater than the second degree of subcooling, the difference between the amount of refrigerant flowing through the first heat source-side heat exchanger and the amount of refrigerant flowing through the second heat source-side heat exchanger is reduced by reducing the opening in the opening degree of the second heat source-side flow rate adjustment valve having the lower degree of subcooling to be smaller than the first opening degree. Therefore, it is possible to inhibit refrigerant drift in the first heat source-side heat exchanger and the second heat source-side heat exchanger.

In this air-conditioning apparatus, it is thereby possible to inhibit refrigerant drift by a simple configuration.

The air-conditioning apparatus according to a fourth aspect of the present invention is the air-conditioning apparatus according to any of the first through third aspects, wherein the controller determines the amount of refrigerant in the refrigerant circuit on the basis of either the first degree of subcooling or the second degree of subcooling. In this air-conditioning apparatus, since the difference between the amounts of refrigerant flowing through the first heat source-side heat exchanger and the second heat source-side heat exchanger is controlled by the controller so as to decrease, the difference between the first degree of subcooling and the second degree of subcooling decreases. Therefore, the amount of refrigerant charged into the refrigerant circuit can be determined from the degree of subcooling in the outlet of either one of the installed heat source-side heat exchangers.

The amount of refrigerant charged into the refrigerant circuit can thereby be easily determined.

The air-conditioning apparatus according to a fifth aspect of the present invention is the air-conditioning apparatus according to any of the first through fourth aspects, further comprising a usage unit having a usage-side heat exchanger and a usage-side flow rate adjustment mechanism. The usage-side heat exchanger functions at least as an evaporator. The usage-side flow rate adjustment mechanism adjusts the flow rate of refrigerant flowing through the usage-side heat exchanger. The refrigerant circuit further has the usage-side heat exchanger and the usage-side flow rate adjustment mechanism. The controller controls the usage-side flow rate adjustment mechanism so that the degree of superheat in the outlet side of the usage-side heat exchanger reaches a predetermined value when refrigerant is charged into the refrigerant circuit.

With the air-conditioning apparatus according to the fifth aspect, the opening degree of the usage-side flow rate adjustment mechanism is adjusted based on the degree of superheat in the outlet side of the usage-side heat exchanger when refrigerant is charged into the refrigerant circuit. Therefore, the amount of refrigerant flowing to the usage-side heat exchanger can be adjusted. Consequently, the amount of refrigerant flowing through the usage-side heat exchanger can be kept constant.

It is thereby possible to improve the precision of determining the amount of refrigerant charged into the refrigerant circuit when refrigerant is charged into the refrigerant circuit.

The air-conditioning apparatus according to a sixth aspect of the present invention comprises first through n-th heat source units, first through n-th determination units, and a controller. The first through n-th heat source units have first through n-th heat source-side heat exchangers and first through n-th heat source-side flow rate adjustment means. The first through n-th heat source-side heat exchangers function at least as condensers. The first through n-th heat source-side flow rate adjustment means adjust the flow rate of refrigerant flowing through the first through n-th heat source-side heat exchangers. The first through n-th determination units determine first through n-th degrees of subcooling in outlet sides of the first through n-th heat source-side heat exchangers. The controller controls the first through n-th heat source-side flow rate adjustment means so that the first through n-th degrees of subcooling come to be equal when refrigerant is charged into a refrigerant circuit having the first through n-th heat source-side heat exchangers and the first through n-th heat source-side flow rate adjustment means.

The air-conditioning apparatus according to the sixth aspect of the present invention comprises a controller for controlling the first through n-th heat source-side flow rate adjustment means. The control controls all of the first through n-th heat source-side flow rate adjustment means so that the first through n-th degrees of subcooling come to be equal. Therefore, the amounts of refrigerant flowing through the first through n-th heat source-side heat exchangers come to be equal. Consequently, refrigerant drift does not readily occur in all of the first through n-th heat source-side heat exchangers.

It is thereby possible to improve the precision of determining the amount of refrigerant charged into the refrigerant circuit when refrigerant is charged into the refrigerant circuit.

The air-conditioning apparatus according to a seven-th aspect of the present invention is the air-conditioning apparatus according to the sixth aspect, wherein the first through n-th heat source-side flow rate adjustment means are first through n-th heat source-side flow rate adjustment valves. The controller sets the first heat source-side flow rate adjustment valve to a first opening degree and sets the opening degrees of the second through n-th heat source-side flow rate adjustment valves to opening degrees having smaller opening degrees than the first opening degree when the first degree of subcooling is greater than any of the second through n-th degrees of subcooling.

In the air-conditioning apparatus according to the seven-th aspect, the controller adjusts the opening degrees of the first through n-th heat source-side flow rate adjustment valves on the basis of the first through n-th degrees of subcooling. For example, in cases in which the first degree of subcooling is greater than any of the second through n-th degrees of subcooling, the openings in the opening degrees of the second through n-th heat source-side flow rate adjustment valves having lower degrees of subcooling are reduced to be smaller than the first opening degree, whereby the amount of refrigerant flowing through the first heat source-side heat exchanger and the amounts of refrigerant flowing through the second through n-th heat source-side heat exchangers come to be equal. Therefore, it is possible to inhibit refrigerant drift in the first through n-th heat source-side heat exchangers.

With this air-conditioning apparatus, it is thereby possible to inhibit refrigerant drift by a simple configuration.

The air-conditioning apparatus according to an eighth aspect of the present invention is the air-conditioning apparatus according to the first or second aspect, wherein the first heat source-side degree of subcooling adjustment means is a first compressor for compressing refrigerant flowing through the refrigerant circuit. The second heat source-side degree of subcooling adjustment means is a second compressor for compressing refrigerant flowing through the refrigerant circuit. Furthermore, the controller controls the first compressor and the second compressor so that the rotational speed of the first compressor is less than the rotational speed of the second compressor when the first degree of subcooling is greater than the second degree of subcooling.

In the air-conditioning apparatus according to the eighth aspect, the controller adjusts the rotational speeds of the first compressor and second compressor on the basis of the first degree of subcooling and the second degree of subcooling. For example, in cases in which the first degree of subcooling is greater than the second degree of subcooling, the difference between the amount of refrigerant flowing through the first heat source-side heat exchanger and the amount of refrigerant flowing through the second heat source-side heat exchanger can be reduced by increasing the rotational speed of the second compressor having the lower degree of subcooling so that it will be greater than the rotational speed of the first compressor. Therefore, it is possible to inhibit refrigerant drift in the first heat source-side heat exchanger and the second heat source-side heat exchanger.

With this air-conditioning apparatus, it is thereby possible to inhibit refrigerant drift by a simple configuration.

The air-conditioning apparatus according to a nin-th aspect of the present invention is the air-conditioning apparatus according to the first or second aspect, wherein the first heat source-side degree of subcooling adjustment means is a first heat source-side fan for blowing air to the first heat source-side heat exchanger. The second heat source-side degree of subcooling adjustment means is a second heat source-side fan for blowing air to the second heat source-side heat exchanger. Furthermore, the controller controls the first heat source-side fan and the second heat source-side fan so that the rotational speed of the first heat source-side fan is greater than the rotational speed of the second heat source-side fan when the first degree of subcooling is greater than the second degree of subcooling.

In the air-conditioning apparatus according to the nin-th aspect, the controller adjusts the rotational speeds of the first heat source-side fan and the second heat source-side fan on the basis of the first degree of subcooling and the second degree of subcooling. For example, in cases in which the first degree of subcooling is greater than the second degree of subcooling, the difference between the first degree of subcooling and the second degree of subcooling can be reduced by increasing the rotational speed of the first heat source-side fan so that it will be greater than the rotational speed of the second heat source-side fan.

### ADVANTAGEOUS EFFECTS OF INVENTION

With the air-conditioning apparatus according to the first aspect, it is possible to improve the precision of determining the amount of refrigerant charged into the refrigerant circuit when refrigerant is charged into the refrigerant circuit.

With the air-conditioning apparatus according to the second aspect, it is possible to determine the degree of subcooling using a simple configuration.

With the air-conditioning apparatus according to the third aspect, it is possible to inhibit refrigerant drift using a simple configuration.

With the air-conditioning apparatus according to the fourth aspect, the amount of refrigerant charged into the refrigerant circuit can be easily determined.

With the air-conditioning apparatus according to the fifth aspect, it is possible to improve the precision of determining the amount of refrigerant charged into the refrigerant circuit when refrigerant is charged into the refrigerant circuit.

With the air-conditioning apparatus according to the sixth aspect, it is possible to improve the precision of determining the amount of refrigerant charged into the refrigerant circuit when refrigerant is charged into the refrigerant circuit.

With the air-conditioning apparatus according to the seven-th aspect, it is possible to inhibit refrigerant drift by a simple configuration.

With the air-conditioning apparatus according to the eighth aspect, it is possible to inhibit refrigerant drift by a simple configuration.

With the air-conditioning apparatus according to the nin-th aspect, it is possible to reduce the difference between the first degree of subcooling and the second degree of subcooling.

### BRIEF DESCRIPTION OF THE DRAWINGS

FIG. 1 is a schematic diagram of a refrigerant circuit of an air-conditioning apparatus according to an embodiment of the present invention.

FIG. 2 is a control block diagram of the air-conditioning apparatus according to an embodiment of the present invention.

FIG. 3 is a flowchart of the refrigerant-charging initiation operation in the air-conditioning apparatus according to an embodiment of the present invention.

FIG. 4 is a flowchart of the refrigerant stabilizing operation in the air-conditioning apparatus according to an embodiment of the present invention.

FIG. 5 is a flowchart of the refrigerant-charging completion operation in the air-conditioning apparatus according to an embodiment of the present invention.

FIG. 6 is a schematic diagram of a refrigerant circuit of the air-conditioning apparatus according to Modification (A) of the present invention.

FIG. 7 is a control block diagram of the air-conditioning apparatus according to Modification (A) of the present invention.

FIG. 8 is a flowchart of the refrigerant-charging initiation operation in the air-conditioning apparatus according to Modification (A) of the present invention.

FIG. 9 is a flowchart of the refrigerant stabilizing operation in the air-conditioning apparatus according to Modification (A) of the present invention.

FIG. 10 is a flowchart of the refrigerant-charging completion operation in the air-conditioning apparatus according to Modification (A) of the present invention.

FIG. 11 is a flowchart of the refrigerant stabilizing operation in the air-conditioning apparatus according to Modification (C) of the present invention.

FIG. 12 is a flowchart of the refrigerant stabilizing operation in the air-conditioning apparatus according to Modification (C) of the present invention.

### EXPLANATION OF THE REFERENCE NUMERALS

1a First outdoor unit (first heat source unit)
1b Second outdoor unit (second heat source unit)
2a First indoor unit (usage unit)
2b Second indoor unit (usage unit)
2c Third indoor unit (usage unit)
3a First outdoor expansion valve (first heat source-side degree of subcooling adjustment means, first heat source-side flow rate adjustment valve)
3b Second outdoor expansion valve (second heat source-side degree of subcooling adjustment means, second heat source-side flow rate adjustment valve)
4a First outdoor heat exchanger (first heat source-side heat exchanger)
4b Second outdoor heat exchanger (second heat source-side heat exchanger)
5a First indoor expansion valve (usage-side flow rate adjustment mechanism)
5b Second indoor expansion valve (usage-side flow rate adjustment mechanism)
5c Third indoor expansion valve (usage-side flow rate adjustment mechanism)
6a First indoor heat exchanger (usage-side heat exchanger)
6b Second indoor heat exchanger (usage-side heat exchanger)
6c Third indoor heat exchanger (usage-side heat exchanger)
8a First compressor (first heat source-side degree of subcooling adjustment means)
8b Second compressor (second heat source-side degree of subcooling adjustment means)
9a First outdoor fan (first heat source-side degree of subcooling adjustment means, first heat source-side fan)
9b Second outdoor fan (second heat source-side degree of subcooling adjustment means, second heat source-side fan)
10, 110 Main refrigerant circuit (refrigerant circuit)
22a First outdoor heat exchange temperature sensor (first temperature sensor)
22b Second outdoor heat exchange temperature sensor (second temperature sensor)
23a First outdoor heat exchange liquid-side temperature sensor (first temperature sensor)
23b Second outdoor heat exchange liquid-side temperature sensor (second temperature sensor)
62a First outdoor-side determination unit (first determination unit)
62b Second outdoor-side determination unit (second determination unit)
64a, 164a First outdoor-side opening degree adjustment component (controller)
64b, 164b Second outdoor-side opening degree adjustment component (controller)
100, 200 Air-conditioning apparatus
101a First outdoor unit (first to n-th heat source unit)
101b Second outdoor unit (first to n-th heat source unit)
101c Third outdoor unit (first to n-th heat source unit)
103a First outdoor expansion valve (first to n-th heat source-side flow rate adjustment means, first to n-th heat-source side flow rate adjustment valve)
103b Second outdoor expansion valve (first to n-th heat source-side flow rate adjustment means, first to n-th heat-source side flow rate adjustment valve)
103c Third outdoor expansion valve (first to n-th heat source-side flow rate adjustment means, first to n-th heat-source side flow rate adjustment valve)
104a First outdoor heat exchanger (first to n-th heat source-side heat exchanger)
104b Second outdoor heat exchanger (first to n-th heat source-side heat exchanger)
104c Third outdoor heat exchanger (first to n-th heat source-side heat exchanger)
162a First outdoor-side determination unit (first to n-th determination unit)
162b Second outdoor-side determination unit (first to n-th determination unit)
162c Third outdoor-side determination unit (first to n-th determination unit)
164c Outdoor-side opening degree adjustment component (controller)

### BEST MODE FOR CARRYING OUT THE INVENTION

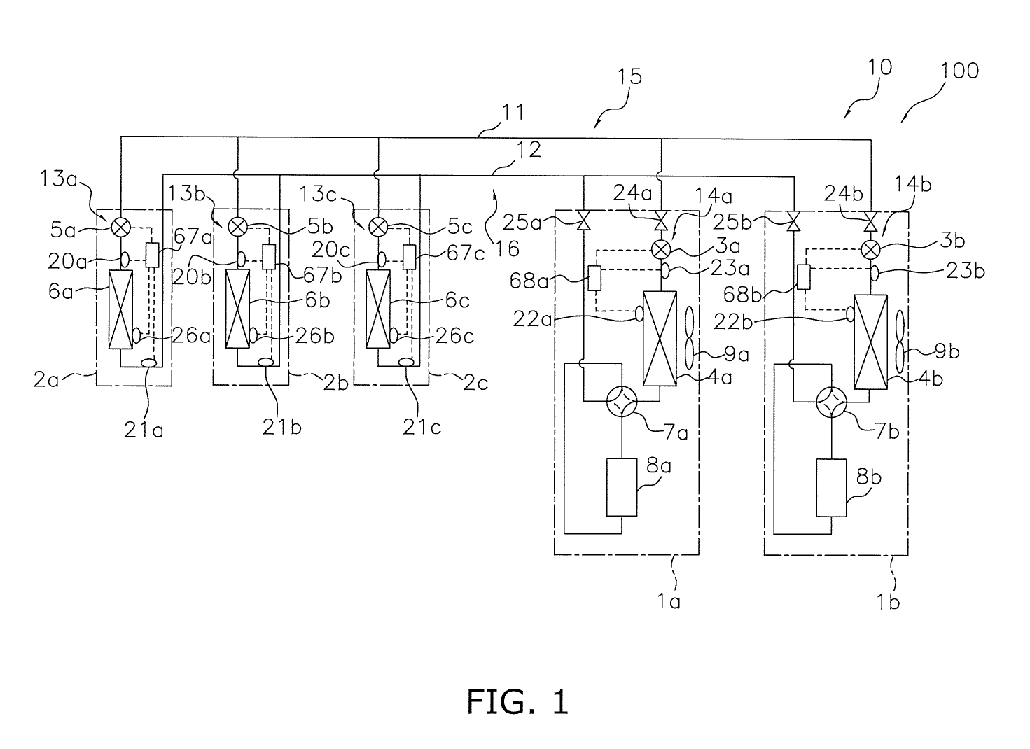

A schematic diagram of a refrigerant circuit of an air-conditioning apparatus 100 according to an embodiment of the present invention is shown in FIG. 1. The air-conditioning apparatus 100 is an apparatus used to cool and heat a room interior in a building or the like by performing a vapor compression refrigeration cycle operation. The air-conditioning apparatus 100 primarily comprises two outdoor units 1a, 1b, three indoor units 2a, 2b, 2c connected in parallel to the outdoor units 1a, 1b, and refrigerant communication pipes for connecting the outdoor units 1a, 1b and the indoor units 2a, 2b, 2c. The refrigerant communication pipes are configured from a liquid refrigerant communication pipe 11 and a gas refrigerant communication pipe 12. Specifically, the liquid refrigerant communication pipe 11 and the gas refrigerant communication pipe 12 are connected to outdoor-side refrigerant circuits 14a, 14b of the outdoor units 1a, 1b and indoor-side refrigerant circuits 13a, 13b, 13c of the indoor units 2a, 2b, 2c. Specifically, a refrigerant circuit 10 of the air-conditioning apparatus 100 is configured by connecting the outdoor-side refrigerant circuits 14a, 14b, the indoor-side refrigerant circuits 13a, 13b, 13c, the liquid refrigerant communication pipe 11, and the gas refrigerant communication pipe 12. In the refrigerant circuit 10, a liquid refrigerant pipe 15 refers to a pipe through which passes refrigerant flowing from a heat exchanger functioning as a condenser to a heat exchanger functioning as an evaporator, and a gas refrigerant pipe 16 refers to a pipe through which passes refrigerant flowing from a heat exchanger functioning as an evaporator to a heat exchanger functioning as a condenser. Hereinbelow, among the various devices provided to the hereinafter-described refrigerant circuit 10, the sides connected to the liquid refrigerant pipe 15 are referred to as the liquid sides of the various devices, and the sides connected to the gas refrigerant pipe 16 are referred to as the gas sides of the various devices.

<Indoor Units>

The first indoor unit 2a, the second indoor unit 2b, and the third indoor unit 2c are embedded in or suspended from a ceiling of a room interior in a building or the like, or hung on the surface of a wall of a room interior. The first indoor unit 2a, the second indoor unit 2b, and the third indoor unit 2c are connected to the first outdoor unit 1a and the second outdoor unit 1b via the liquid refrigerant communication pipe 11 and the gas refrigerant communication pipe 12, constituting part of the refrigerant circuit 10.

Next, the configuration of the first indoor unit 2a will be described. The first indoor unit 2a has the same configuration as the second indoor unit 2b and the third indoor unit 2c, and therefore only the configuration of the first indoor unit 2a shall be described.

The first indoor unit 2a comprises primarily a first indoor expansion valve 5a, a first indoor heat exchanger 6a, a first indoor heat exchange liquid-side temperature sensor 20a, a first indoor heat exchange gas-side temperature sensor 21a, and a first indoor heat exchange temperature sensor 26a. A first indoor-side refrigerant circuit 13a as part of the refrigerant circuit 10 is configured by connecting the first indoor expansion valve 5a and the first indoor heat exchanger 6a using a refrigerant pipe.

The first indoor expansion valve 5a is an electric expansion valve connected to the liquid side of the first indoor heat exchanger 6a in order to adjust the amount of refrigerant flowing through the first indoor-side refrigerant circuit 13a and to perform other functions.

The first indoor heat exchanger 6a is a cross-fin type fin-and-pipe heat exchanger configured from a heat-transfer pipe and numerous fins. The first indoor heat exchanger 6a functions as a refrigerant evaporator during the cooling operation to cool air in the room interior, and functions as a refrigerant condenser during the heating operation to heat air in the room interior.

The first indoor heat exchange liquid-side temperature sensor 20a is provided to the liquid side of the first indoor heat exchanger 6a, and this sensor detects the temperature of refrigerant in a liquid state or a gas-liquid two-phase state. The first indoor heat exchange gas-side temperature sensor 21a is provided to the gas side of the first indoor heat exchanger 6a, and this sensor detects the temperature of the refrigerant in a gas state or a gas-liquid two-phase state. The first indoor heat exchange temperature sensor 26a is provided to the first indoor heat exchanger 6a, and this sensor detects the temperature of refrigerant flowing through the first indoor heat exchanger 6a. In the present embodiment, the first indoor heat exchange liquid-side temperature sensor 20a, the first indoor heat exchange gas-side temperature sensor 21a, and the first indoor heat exchange temperature sensor 26a are composed of thermistors.

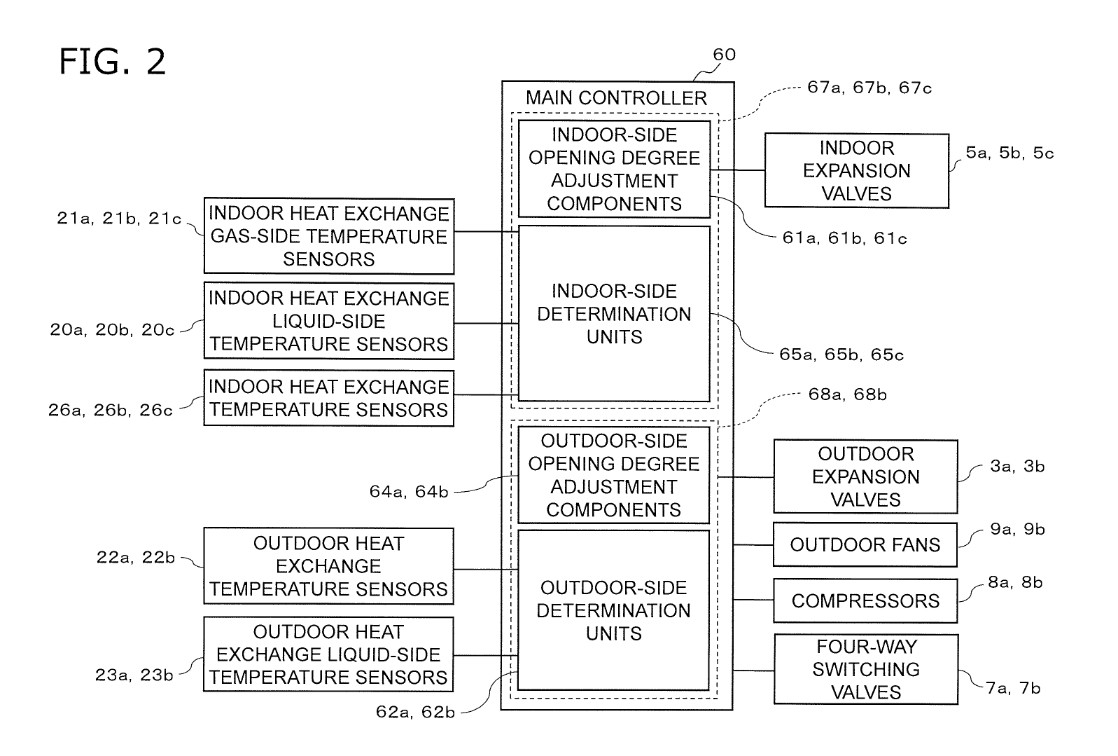

The first indoor unit 2a comprises a first indoor-side controller 67a for controlling the various devices and valves of the first indoor unit 2a, as shown in FIG. 2. The first indoor-side controller 67a has a first indoor-side determination unit 65a and a first indoor-side opening degree adjustment component 61a. Based on the refrigerant temperatures detected by the first indoor heat exchange liquid-side temperature sensor 20a, the first indoor heat exchange gas-side temperature sensor 21a, and the first indoor heat exchange temperature sensor 26a, the first indoor-side determination unit 65a calculates the degree of superheat when the first indoor heat exchanger 6a is functioning as an evaporator, and calculates the degree of subcooling when the first indoor heat exchanger 6a is functioning as a condenser. The first indoor-side opening degree adjustment component 61a adjusts the opening degree of the first indoor expansion valve 5a on the basis of the degree of superheat or the degree of subcooling calculated by the first indoor-side determination unit 65a. Furthermore, the first indoor-side controller 67a has a microcomputer, a memory, or the like provided in order to control the first indoor unit 2a, and this controller is capable of exchanging control signals and the like with a remote controller (not shown) for individually operating the first indoor unit 2a, and of exchanging control signals and the like with the first outdoor unit 1a and the second outdoor unit 1b.

<Outdoor Units>

The first outdoor unit 1a and the second outdoor unit 1b are installed on the roof or another location in a building or the like, and are connected to the first indoor unit 2a, the second indoor unit 2b, and the third indoor unit 2c via the liquid refrigerant communication pipe 11 and the gas refrigerant communication pipe 12.

Next, the configuration of the first outdoor unit 1a will be described. The first outdoor unit 1a and the second outdoor unit 1b have the same configuration, and therefore only the configuration of the first outdoor unit 1a is described herein.

The first outdoor unit 1a primarily comprises a first compressor 8a, a first four-way switching valve 7a, a first outdoor heat exchanger 4a, a first outdoor expansion valve 3a, a first outdoor fan 9a, a first liquid-side shutoff valve 24a, a first gas-side shutoff valve 25a, a first outdoor heat exchange temperature sensor 22a, and a first outdoor heat exchange liquid-side temperature sensor 23a. In the first outdoor unit 1a, a first outdoor-side refrigerant circuit 14a that constitutes a part of the refrigerant circuit 10 is configured by connecting the first compressor 8a, the first four-way switching valve 7a, the first outdoor heat exchanger 4a, the first outdoor expansion valve 3a, the first liquid-side shutoff valve 24a, and the first gas-side shutoff valve 25a.

The first compressor 8a is a device for compressing low-pressure gas refrigerant taken in from an intake side and discharging the compressed high-pressure gas refrigerant to a discharge side. The first compressor 8a is a compressor whose operating capacity can be varied, and is driven by a motor controlled by an inverter.

The first four-way switching valve 7a is a valve for switching the direction of refrigerant flow, and during the cooling operation and the refrigerant charging operation, this valve connects the discharge side of the first compressor 8a with the gas side of the first outdoor heat exchanger 4a and connects the intake side of the first compressor 8a with the gas refrigerant communication pipe 12 (refer to the solid lines of the first four-way switching valve 7a in FIG. 1). Therefore, during the cooling operation and the refrigerant charging operation, the first outdoor heat exchanger 4a functions as a condenser of the refrigerant compressed in the first compressor 8a, and the first indoor heat exchanger 6a, the second indoor heat exchanger 6b, and the third indoor heat exchanger 6c function as evaporators of the refrigerant condensed in the first outdoor heat exchanger 4a. During the heating operation, the first four-way switching valve 7a connects the discharge side of the first compressor 8a with the gas refrigerant communication pipe 12 and connects the intake side of the first compressor 8a with the gas side of the first outdoor heat exchanger 4a (refer to the dashed lines of the first four-way switching valve 7a in FIG. 1). Therefore, during the heating operation, the first indoor heat exchanger 6a, the second indoor heat exchanger 6b, and the third indoor heat exchanger 6c function as condensers of the refrigerant compressed in the first compressor 8a, and the first outdoor heat exchanger 4a functions as an evaporator of the refrigerant condensed in the first indoor heat exchanger 6a, the second indoor heat exchanger 6b, and the third indoor heat exchanger 6c.

The first outdoor heat exchanger 4a is a cross-fin type fin-and-pipe heat exchanger configured from a heat-transfer pipe and numerous fins, and this heat exchanger functions as a refrigerant condenser during the cooling operation and as a refrigerant evaporator during the heating operation. The gas side of the first outdoor heat exchanger 4a is connected to the first four-way switching valve 7a, and the liquid side is connected to the first outdoor expansion valve 3a.

The first outdoor expansion valve 3a is an electric expansion valve connected to the liquid side of the first outdoor heat exchanger 4a in order to adjust the amount of refrigerant flowing through the first outdoor-side refrigerant circuit 14a, and to perform other functions.

The first outdoor fan 9a is a propeller fan disposed in proximity to the first outdoor heat exchanger 4a in order to supply outdoor air to the first outdoor heat exchanger 4a.

The first liquid-side shutoff valve 24a is a valve provided to the connection port between the liquid refrigerant communication pipe 11 and the first outdoor unit 1a. The first gas-side shutoff valve 25a is a valve provided to the connection port between the gas refrigerant communication pipe 12 and the first outdoor unit 1a. The first liquid-side shutoff valve 24a is connected to the first outdoor expansion valve 3a. The first gas-side shutoff valve 25a is connected to the first four-way switching valve 7a.

The first outdoor heat exchange temperature sensor 22a is provided to the first outdoor heat exchanger 4a, and this sensor detects the temperature of refrigerant flowing through the first outdoor heat exchanger 4a. The first outdoor heat exchange liquid-side temperature sensor 23a is provided to the liquid side of the first outdoor heat exchanger 4a, and this sensor detects the temperature of liquid or gas-liquid two-phase refrigerant. In the present embodiment, the first outdoor heat exchange temperature sensor 22a and the first outdoor heat exchange liquid-side temperature sensor 23a are composed of thermistors.

The first outdoor unit 1a also comprises a first outdoor-side controller 68a for controlling the various devices and valves of the first outdoor unit 1a, as shown in FIG. 2. The first outdoor-side controller 68a has a first outdoor-side determination unit 62a and a first outdoor-side opening degree adjustment component 64a. The first outdoor-side determination unit 62a is connected to the first outdoor heat exchange temperature sensor 22a and the first outdoor heat exchange liquid-side temperature sensor 23a, and based on the refrigerant temperature detected by the first outdoor heat exchange temperature sensor 22a and the first outdoor heat exchange liquid-side temperature sensor 23a, this determination unit calculates the degree of subcooling in the liquid side of the first outdoor heat exchanger 4a functioning as a condenser. The first outdoor-side opening degree adjustment component 64a sets as the non-target unit the outdoor unit that has the outdoor heat exchanger in which was calculated the greater degree of subcooling of the degrees of subcooling calculated by the outdoor-side determination units 62a, 62b, and sets the outdoor unit other than the non-target unit as the target unit. The first outdoor-side opening degree adjustment component 64a is connected to the first outdoor expansion valve 3a, and this adjustment component adjusts the opening degree of the first outdoor expansion valve 3a on the basis of the degree of subcooling calculated by the first outdoor-side determination unit 62a. Furthermore, the first outdoor-side controller 68a performs a comparison between the degree of subcooling of the non-target unit and a predetermined value set as a target value for the completion of refrigerant charging, and also performs a comparison between the target unit and the non-target unit. The first outdoor-side controller 68a has a microcomputer provided in order to control the first outdoor unit 1a, an inverter circuit for controlling the memory and motor, and other components; and can exchange control signals and the like with the first indoor-side controller 67a, a second indoor-side controller 67b, and a third indoor-side controller 67c.

As described above, the refrigerant circuit 10 of the air-conditioning apparatus 100 is configured by connecting the first indoor-side refrigerant circuit 13a, the second indoor-side refrigerant circuit 13b, and the third indoor-side refrigerant circuit 13c with the first outdoor-side refrigerant circuit 14a and the second outdoor-side refrigerant circuit 14b by refrigerant communication pipes. A main controller 60 is configured by the first indoor-side controller 67a, the second indoor-side controller 67b, the third indoor-side controller 67c, the first outdoor-side controller 68a, and the second outdoor-side controller 68b, as shown in FIG. 2. The main controller 60 is connected to the first four-way switching valve 7a, the second four-way switching valve 7b, the first compressor 8a, and the second compressor 8b so as to be capable of controlling these components. The main controller 60 is designed so as to perform the cooling operation and heating operation by switching the first four-way switching valve 7a and the second four-way switching valve 7b, and to control the first compressor 8a of the first outdoor unit 1a, the second compressor 8b of the second outdoor unit 1b, and other devices in accordance with the operating loads of the first indoor unit 2a, the second indoor unit 2b, and the third indoor unit 2c. The main controller 60 can thereby control the operation of the entire air-conditioning apparatus 100.

<Action of Air-Conditioning Apparatus>

Next, the action of the air-conditioning apparatus 100 of the present embodiment will be described.

The operation modes of the air-conditioning apparatus 100 of the present embodiment include a normal operation mode for controlling the various devices of the first outdoor unit 1a, the second outdoor unit 1b, the first indoor unit 2a, the second indoor unit 2b, and the third indoor unit 2c in accordance with the operating loads of the first indoor unit 2a, the second indoor unit 2b, and the third indoor unit 2c; and a refrigerant-charging operation mode for charging refrigerant into the refrigerant circuit 10, which is performed after the air-conditioning apparatus 100 is installed. The normal operation mode includes primarily a cooling operation and a heating operation.

The actions of the operation modes of the air-conditioning apparatus 100 are described hereinbelow.

<Normal Operation Mode>

First, the cooling operation in the normal operation mode will be described using FIG. 1.

During the cooling operation, the first four-way switching valve 7a and the second four-way switching valve 7b are in the state shown by the solid lines in FIG. 1; i.e., a state in which the discharge side of the first compressor 8a is connected to the gas side of the first outdoor heat exchanger 4a and the discharge side of the second compressor 8b is connected to the gas side of the second outdoor heat exchanger 4b, while the intake sides of the first compressor 8a and second compressor 8b are connected to the gas sides of the first indoor heat exchanger 6a, the second indoor heat exchanger 6b, and the third indoor heat exchanger 6c. The first outdoor expansion valve 3a and the second outdoor expansion valve 3b are in an open state, and the opening degrees of the first indoor expansion valve 5a, the second indoor expansion valve 5b, and the third indoor expansion valve 5c are adjusted so that the degrees of superheat of the refrigerant in the gas sides of the first indoor heat exchanger 6a, the second indoor heat exchanger 6b, and the third indoor heat exchanger 6c reach a predetermined value. In the present embodiment, the degrees of superheat of the refrigerant in the gas sides of the first indoor heat exchanger 6a, the second indoor heat exchanger 6b, and the third indoor heat exchanger 6c are detected by subtracting the refrigerant temperatures detected by the first indoor heat exchange liquid-side temperature sensor 20a, the second indoor heat exchange liquid-side temperature sensor 20b, and the third indoor heat exchange liquid-side temperature sensor 20c from the refrigerant temperature values detected by the first indoor heat exchange gas-side temperature sensor 21a, the second indoor heat exchange gas-side temperature sensor 21b, and the third indoor heat exchange gas-side temperature sensor 21c, respectively.

When the first compressor 8a and the second compressor 8b are started up while the refrigerant circuit 10 is in this state, low-pressure gas refrigerant is taken into the first compressor 8a and second compressor 8b and compressed into high-pressure gas refrigerant. This high-pressure gas refrigerant is sent to the first outdoor heat exchanger 4a and second outdoor heat exchanger 4b via the first four-way switching valve 7a and second four-way switching valve 7b, respectively. The high-pressure gas refrigerant sent to the first outdoor heat exchanger 4a and second outdoor heat exchanger 4b is subjected to heat exchange with outdoor air, and is condensed into high-pressure liquid refrigerant.

This high-pressure liquid refrigerant is sent to the first indoor unit 2a, the second indoor unit 2b, and the third indoor unit 2c via the first outdoor expansion valve 3a and the second outdoor expansion valve 3b. The high-pressure liquid refrigerant sent to the first indoor unit 2a, the second indoor unit 2b, and the third indoor unit 2c is depressurized by the first indoor expansion valve 5a, the second indoor expansion valve 5b, and the third indoor expansion valve 5c, resulting in low-pressure gas-liquid two-phase refrigerant, which is sent to the first indoor heat exchanger 6a, the second indoor heat exchanger 6b, and the third indoor heat exchanger 6c. The refrigerant is subjected to heat exchange with indoor air in the first indoor heat exchanger 6a, the second indoor heat exchanger 6b, and the third indoor heat exchanger 6c, and is evaporated to form low-pressure gas refrigerant. The first indoor expansion valve 5a, the second indoor expansion valve 5b, and the third indoor expansion valve 5c control the amount of refrigerant flowing through the first indoor heat exchanger 6a, the second indoor heat exchanger 6b, and the third indoor heat exchanger 6c so that the degrees of superheat in the gas sides of the first indoor heat exchanger 6a, the second indoor heat exchanger 6b, and the third indoor heat exchanger 6c reach a predetermined value. This low-pressure gas refrigerant is sent to the first outdoor unit 1a and the second outdoor unit 1b via the gas refrigerant communication pipe 12, and is taken back into the first compressor 8a and the second compressor 8b via the first four-way switching valve 7a and the second four-way switching valve 7b, respectively.

Next, the heating operation in the normal operation mode will be described.

During the heating operation, the first four-way switching valve 7a and the second four-way switching valve 7b are in the state shown by the dashed lines in FIG. 1; i.e., a state in which the discharge sides of the first compressor 8a and second compressor 8b are connected to the gas sides of the first indoor heat exchanger 6a, the second indoor heat exchanger 6b, and the third indoor heat exchanger 6c, and the intake sides of the first compressor 8a and second compressor 8b are connected to the gas sides of the first outdoor heat exchanger 4a and second outdoor heat exchanger 4b, respectively. The first outdoor expansion valve 3a and the second outdoor expansion valve 3b are in an open state, and the opening degrees of the first indoor expansion valve 5a, the second indoor expansion valve 5b, and the third indoor expansion valve 5c are adjusted so that the degrees of subcooling of the refrigerant in the liquid sides of the first indoor heat exchanger 6a, the second indoor heat exchanger 6b, and the third indoor heat exchanger 6c reach a predetermined value. In the present embodiment, the degrees of subcooling of the refrigerant in the liquid sides of the first indoor heat exchanger 6a, the second indoor heat exchanger 6b, and the third indoor heat exchanger 6c are detected by subtracting the refrigerant temperatures detected by the first indoor heat exchange liquid-side temperature sensor 20a, the second indoor heat exchange liquid-side temperature sensor 20b, and the third indoor heat exchange liquid-side temperature sensor 20c from the refrigerant temperatures detected by the first indoor heat exchange temperature sensor 26a, the second indoor heat exchange temperature sensor 26b, and the third indoor heat exchange temperature sensor 26c, respectively.

When the first compressor 8a and the second compressor 8b are started up while the refrigerant circuit 10 is in this state, low-pressure gas refrigerant is taken into the first compressor 8a and the second compressor 8b and compressed into high-pressure gas refrigerant, which is sent to the first indoor unit 2a, the second indoor unit 2b, and the third indoor unit 2c via the first four-way switching valve 7a and the second four-way switching valve 7b.

The high-pressure gas refrigerant sent to the first indoor unit 2a, the second indoor unit 2b, and the third indoor unit 2c exchanges heat with indoor air and condensed in the first indoor heat exchanger 6a, the second indoor heat exchanger 6b, and the third indoor heat exchanger 6c, forming high-pressure liquid refrigerant, which is then depressurized by the first indoor expansion valve 5a, the second indoor expansion valve 5b, and the third indoor expansion valve 5c, forming low-pressure gas-liquid two-phase refrigerant. The first indoor expansion valve 5a, the second indoor expansion valve 5b, and the third indoor expansion valve 5c control the respective amounts of refrigerant flowing through the first indoor heat exchanger 6a, the second indoor heat exchanger 6b, and the third indoor heat exchanger 6c so that the degrees of subcooling in the liquid sides of the first indoor heat exchanger 6a, the second indoor heat exchanger 6b, and the third indoor heat exchanger 6c reach a predetermined value. This low-pressure gas-liquid two-phase refrigerant is sent to the first outdoor unit 1a and the second outdoor unit 1b via the liquid refrigerant communication pipe 11. The low-pressure gas-liquid two-phase refrigerant sent to the first outdoor unit 1a and the second outdoor unit 1b is sent respectively to the first outdoor heat exchanger 4a and the second outdoor heat exchanger 4b, and subjected to heat exchange with outdoor air and condensed into low-pressure gas refrigerant, which is taken back into the first compressor 8a and the second compressor 8b via the first four-way switching valve 7a and the second four-way switching valve 7b, respectively.

Thus, when the normal operation mode is performed in the air-conditioning apparatus 100, amounts of refrigerant flow respectively to the first indoor heat exchanger 6a, the second indoor heat exchanger 6b, and the third indoor heat exchanger 6c; the amounts of refrigerant corresponding to the operating loads required in the air-conditioned spaces in which the first indoor unit 2a, the second indoor unit 2b, and the third indoor unit 2c are installed.

<Refrigerant-Charging Operation Mode>

Next, the refrigerant-charging operation mode will be described using FIGS. 1, 2, 3, 4, and 5.

In the present embodiment, an example is described in which the first indoor unit 2a, the second indoor unit 2b, and the third indoor unit 2c, as well as the first outdoor unit 1a and the second outdoor unit 1b which are charged in advance with predetermined amounts of refrigerant, are installed at the installation site; and the first indoor unit 2a, the second indoor unit 2b, and the third indoor unit 2c are connected with the first outdoor unit 1a and the second outdoor unit 1b via the liquid refrigerant communication pipe 11 and the gas refrigerant communication pipe 12, constituting the refrigerant circuit 10. An additional amount of refrigerant that was insufficient according to the lengths of the liquid refrigerant communication pipe 11 and the gas refrigerant communication pipe 12 is then charged into the refrigerant circuit 10. The process of step S1 through step S3 in the refrigerant charging operation described hereinafter is hereinbelow referred to as the refrigerant-charging initiation operation, the process of step S4 through step S8 is referred to as the refrigerant stabilizing operation, and the process of step S9 through step S14 is referred to as the refrigerant-charging completion operation.

First, an operator performing the refrigerant charging opens the first liquid-side shutoff valve 24a and the second liquid-side shutoff valve 24b as well as the first gas-side shutoff valve 25a and the second gas-side shutoff valve 25b of the first outdoor unit 1a and the second outdoor unit 1b respectively, and fills the refrigerant circuit 10 with the refrigerant that had been charged in advance into the first outdoor unit 1a and the second outdoor unit 1b.

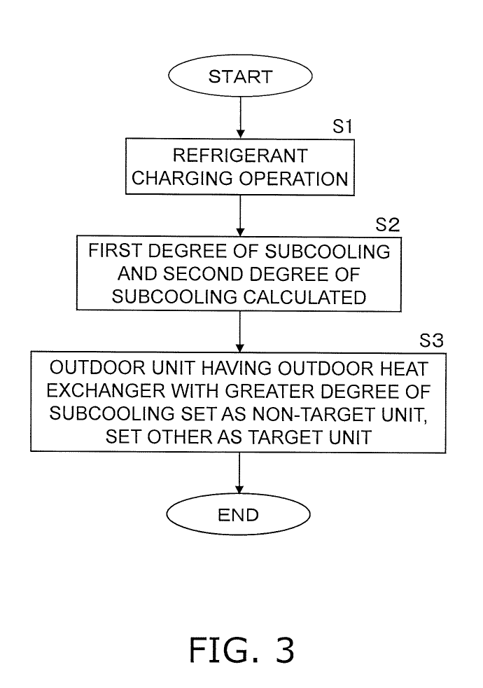

Next, the operator performing the refrigerant charging connects a charge port installed near the first gas-side shutoff valve 25a with a cylinder (not shown) in which refrigerant is sealed, using a charging pipe provided with a charging valve. When the operator performing the refrigerant charging then issues a refrigerant charging operation command to initiate the refrigerant charging, either directly to the main controller 60 or remotely via a remote controller or the like, the process of step S1 shown in FIG. 3 is performed by the main controller 60.

When an initiation command for the refrigerant charging operation is issued, the first four-way switching valve 7a and the second four-way switching valve 7b in the first outdoor unit 1a and the second outdoor unit 1b are set to the state shown by the solid lines in FIG. 1, the first outdoor expansion valve 3a and the second outdoor expansion valve 3b are both set to an open state, and the first indoor expansion valve 5a, the second indoor expansion valve 5b, and the third indoor expansion valve 5c of the first indoor unit 2a, the second indoor unit 2b, and the third indoor unit 2c are all set to an open state. When the first compressor 8a and the second compressor 8b are started up during this state of the refrigerant circuit 10, this forces the cooling operation to be performed. The refrigerant already charged into the refrigerant circuit 10 can be stabilized by performing the cooling operation for a predetermined amount of time. After a predetermined amount of time has elapsed since the performing of the cooling operation, the charging valve is set to an open state while the cooling operation continues to be performed, and refrigerant is supplied from the cylinder into the refrigerant circuit 10. The refrigerant charging operation is thereby initiated.

In the refrigerant circuit 10 at this time, high-pressure gas refrigerant compressed in the first compressor 8a and the second compressor 8b and discharged then flows through the flow passages running from the first compressor 8a and the second compressor 8b to the first outdoor heat exchanger 4a and the second outdoor heat exchanger 4b functioning as condensers; high-pressure refrigerant changing from a gas phase state to a liquid phase state through heat exchange with outdoor air flows into the first outdoor heat exchanger 4a and the second outdoor heat exchanger 4b functioning as condensers; high-pressure liquid refrigerant flows through flow passages running from the first outdoor heat exchanger 4a and the second outdoor heat exchanger 4b to the first indoor expansion valve 5a, the second indoor expansion valve 5b, and the third indoor expansion valve 5c, which includes the liquid refrigerant communication pipe 11 via the first outdoor expansion valve 3a and the second outdoor expansion valve 3b; low-pressure refrigerant changing from a gas-liquid two-phase state to a gas phase state through heat exchange with indoor air flows into the first indoor heat exchanger 6a, the second indoor heat exchanger 6b, and the third indoor heat exchanger 6c functioning as evaporators; and low-pressure gas refrigerant flows through flow passages running from the first indoor heat exchanger 6a, the second indoor heat exchanger 6b, and the third indoor heat exchanger 6c to the first compressor 8a and the second compressor 8b, and also including the gas refrigerant communication pipe 12. At this time, indoor-side opening degree adjustment components 67a, 67b, 67c adjust the respective opening degrees of the first indoor expansion valve 5a, the second indoor expansion valve 5b, and the third indoor expansion valve 5c so that each of the degrees of superheat of the refrigerant in the gas sides of the first indoor heat exchanger 6a, the second indoor heat exchanger 6b, and the third indoor heat exchanger 6c functioning as evaporators reach a predetermined value. The first outdoor-side determination unit 62a calculates a first degree of subcooling as the subcooling degree of the refrigerant in the liquid side of the first outdoor heat exchanger 4a functioning as a condenser, and the second outdoor-side determination unit 62b calculates a second degree of subcooling as the subcooling degree of the refrigerant in the liquid side of the second outdoor heat exchanger 4b (step S2). Then, the outdoor unit having the outdoor heat exchanger that has the greater degree of subcooling of either the first degree of subcooling or the second degree of subcooling calculated in the first outdoor-side determination unit 62a and the second outdoor-side determination unit 62b is set as a non-target heat exchanger, and the other is set as the target heat exchanger (step S3). The refrigerant-charging initiation operation is thereby completed.

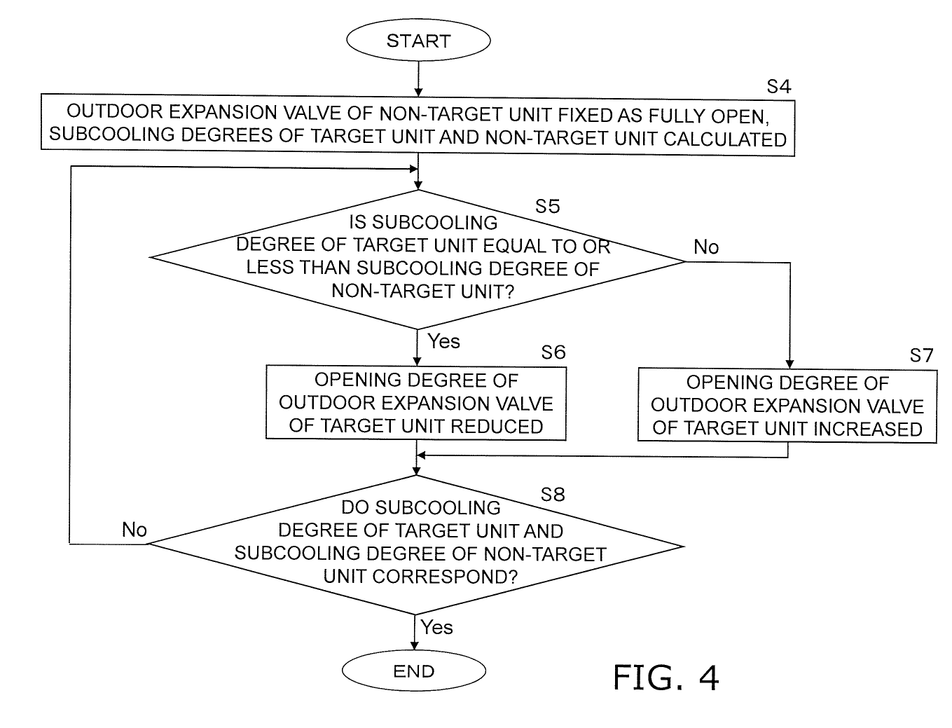

When the refrigerant-charging initiation operation is completed, the opening degree of the outdoor expansion valve of the non-target unit is fixed in a fully open state, and each of the degrees of subcooling of the target unit and the non-target unit are recalculated, as shown in FIG. 4 (step S4). The recalculated subcooling degree of the target unit and the recalculated subcooling degree of the non-target unit are compared (step S5). In cases in which the subcooling degree of the target unit is equal to or less than the subcooling degree of the non-target unit, the opening degree of the outdoor expansion valve of the target unit is reduced (step S6). In cases in which the subcooling degree of the target unit is greater than the subcooling degree of the non-target unit, the opening degree of the outdoor expansion valve of the target unit is increased (step S7). After the opening degree of the outdoor expansion valve of the target unit has been adjusted, the subcooling degree of the target unit and the subcooling degree of the non-target unit are recalculated, and each of the degrees of subcooling are compared (step S8). At this time, in cases in which the degrees of subcooling correspond to each other, the refrigerant stabilizing operation is completed. In cases in which the degrees of subcooling do not correspond respectively, the process moves to step S5, and the degrees of subcooling of the target unit and the non-target unit are compared. Note that this refrigerant stabilizing operation is performed in parallel with a refrigerant-charging completion operation which is described hereinbelow.

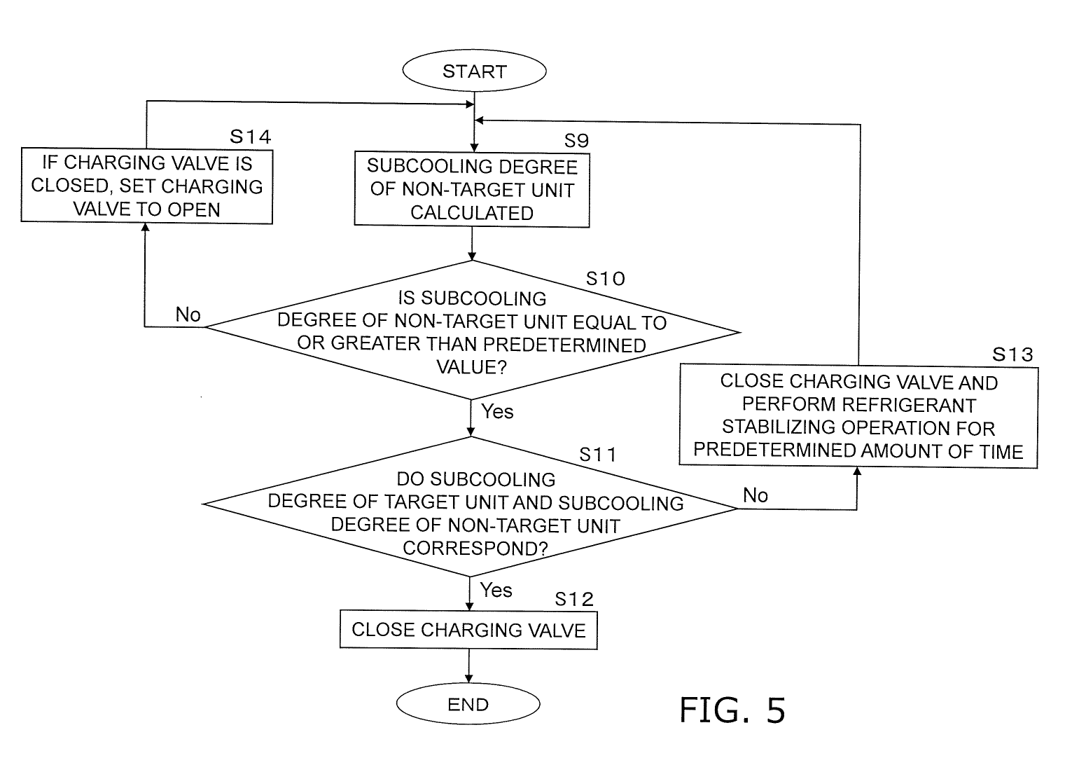

After the refrigerant stabilizing operation has been performed for a predetermined amount of time, the subcooling degree of the non-target unit is recalculated as shown in FIG. 5 (step S9). A comparison is made between the subcooling degree of the non-target unit calculated at this time and a predetermined value set as a target value for refrigerant charging completion (step S10). In cases in which the subcooling degree of the non-target unit at this time is equal to or greater than the predetermined value, the subcooling degree of the non-target unit and the subcooling degree of the target unit are compared (step S11). In cases in which the compared degrees of subcooling correspond to each other, the charging valve is set to a closed state, and the supply of refrigerant from the cylinder is stopped (step S12). The refrigerant-charging completion operation is thereby completed. Therefore, the refrigerant charging operation is completed. When the subcooling degree of the non-target unit and the subcooling degree of the target unit are compared in step S11, the charging valve is set to the closed state and the supply of refrigerant from the cylinder is stopped also in cases in which the degrees of subcooling do not correspond to each other. The refrigerant stabilizing operation is then performed for a predetermined amount of time in a state in which the supply of refrigerant from the cylinder has been stopped (step S13). After the refrigerant stabilizing operation has been performed for a predetermined amount of time, the process moves to step S9, the subcooling degree of the non-target unit is calculated, and a comparison is made between the non-target unit and the predetermined value (step S10). At this time, in cases in which the subcooling degree of the non-target unit is not equal to or greater than the predetermined value, the charging valve is set to an open state and the supply of refrigerant from the cylinder is restarted (step S14). Note that in the present embodiment, step S8 and step S11 are performed until the subcooling degree of the target unit and the subcooling degree of the non-target unit correspond, but these steps may also be performed until both degrees of subcooling enter a predetermined range.

<Characteristics>

(1)

In conventional practice, there are air-conditioning apparatuses comprising one outdoor unit wherein the outdoor heat exchanger is caused to function as a condenser when the refrigerant circuit is charged with refrigerant, the subcooling degree of the refrigerant in the liquid side of the outdoor heat exchanger is detected, and the amount of refrigerant charged into the refrigerant circuit is determined by the degree of subcooling.

However, when the refrigerant circuit is charged with refrigerant in an air-conditioning apparatus comprising a plurality of outdoor units, there are occasions in which the refrigerant drifts due to the installation conditions of each of the outdoor units, the temperature conditions, and other conditions; and each of the degrees of subcooling in each of the outdoor heat exchangers become disproportionate. Therefore, when the amount of refrigerant charged in the refrigerant circuit is determined according to the degrees of subcooling of the refrigerant in the liquid sides of the outdoor heat exchangers, there is a danger of reducing the accuracy of this determination.

To overcome this problem, in the embodiment described above, a first outdoor-side opening degree adjustment component 64a and a second outdoor-side opening degree adjustment component 64b are provided for controlling the first outdoor expansion valve 3a and the second outdoor expansion valve 3b. During the refrigerant-charging initiation operation, the first outdoor-side opening degree adjustment component 64a and the second outdoor-side opening degree adjustment component 64b set as a non-target unit the outdoor unit having the outdoor heat exchanger whose degree of subcooling is the greater of either the calculated first degree of subcooling or the second degree of subcooling, and the other outdoor unit is set as the target unit (step S3). During the refrigerant stabilizing operation, the first outdoor-side opening degree adjustment component 64a and the second outdoor-side opening degree adjustment component 64b fix the opening degree of the outdoor expansion valve of the non-target unit in a fully open state, and adjust the opening degree of the outdoor expansion valve of the target unit (step S4 to step S7). Therefore, the degrees of subcooling of the target unit and non-target unit come to be equal. Consequently, the refrigerant does not readily drift in the outdoor heat exchanger of the target unit and in the outdoor heat exchanger of the non-target unit.

It is thereby possible to improve the precision of determining the amount of refrigerant charged into the refrigerant circuit 10 when refrigerant is charged into the refrigerant circuit 10.

(2)

In the embodiment described above, the first outdoor heat exchange liquid-side temperature sensor 23a and the first outdoor heat exchange temperature sensor 22a are provided in order to calculate the first degree of subcooling of the refrigerant in the liquid side of the first outdoor heat exchanger 4a, and the second outdoor heat exchange liquid-side temperature sensor 23b and the second outdoor heat exchange temperature sensor 22b are provided respectively in order to calculate the second degree of subcooling of the refrigerant in the liquid side of the second outdoor heat exchanger 4b. Therefore, the first outdoor-side determination unit 62a and the second outdoor-side determination unit 62b can calculate the first degree of subcooling and the second degree of subcooling according to the temperature of the refrigerant.

The degree of subcooling can thereby be determined by a simple configuration in the air-conditioning apparatus 100.

(3)

In the embodiment described above, when the refrigerant charging operation is being performed, the opening degrees of the first indoor expansion valve 5a, the second indoor expansion valve 5b, and the third indoor expansion valve 5c are adjusted respectively based on each of the degrees of superheat in the gas sides of the first indoor heat exchanger 6a, the second indoor heat exchanger 6b, and the third indoor heat exchanger 6c. Therefore, the amounts of refrigerant flowing to the first indoor heat exchanger 6a, the second indoor heat exchanger 6b, and the third indoor heat exchanger 6c can be respectively adjusted. Consequently, the amounts of refrigerant flowing through the first indoor heat exchanger 6a, the second indoor heat exchanger 6b, and the third indoor heat exchanger 6c can be kept constant.

It is thereby possible to improve the precision of determining the amount of refrigerant charged into the refrigerant circuit 10 when refrigerant is charged into the refrigerant circuit 10.

<Modifications>

(A)

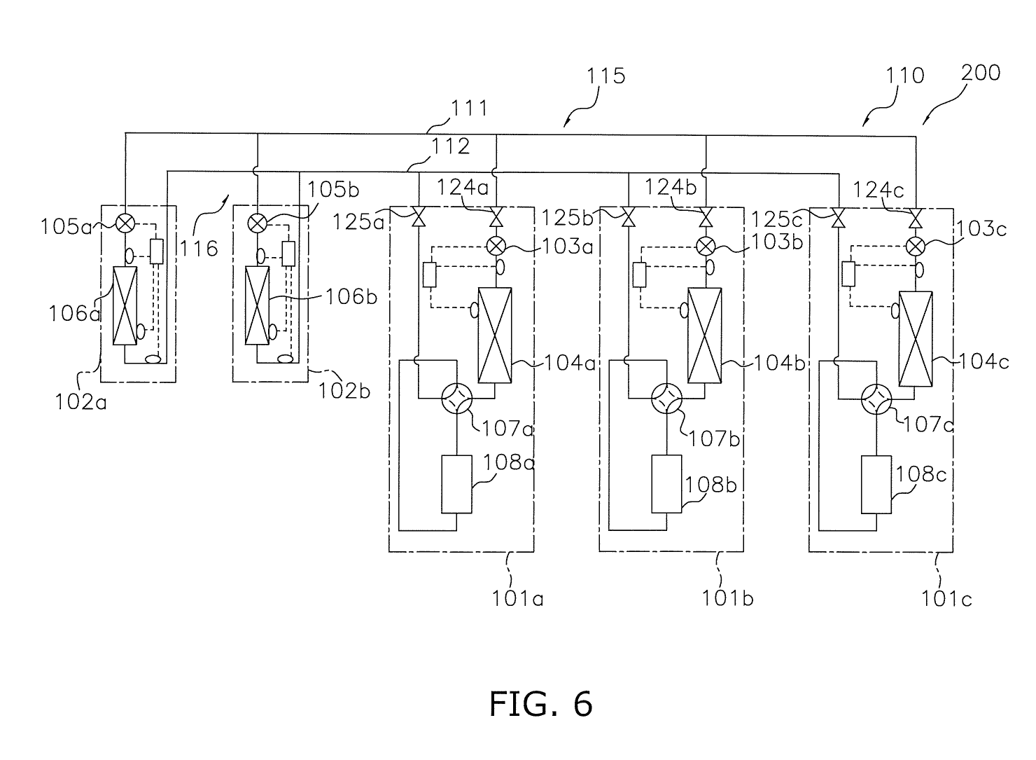

In the embodiment described above, the air-conditioning apparatus 100 comprises two outdoor units, but may also comprise three or more outdoor units. For example, FIG. 6 is used to describe a configuration of an air-conditioning apparatus 200 comprising three outdoor units 101a, 101b, 101c, two indoor units 102a, 102b connected in parallel to the outdoor units 101a, 101b, 101c, and refrigerant communication pipes for connecting the outdoor units 101a, 101b, 101c with the indoor units 102a, 102b. The refrigerant communication pipes are configured from a liquid refrigerant communication pipe 111 and a gas refrigerant communication pipe 112.

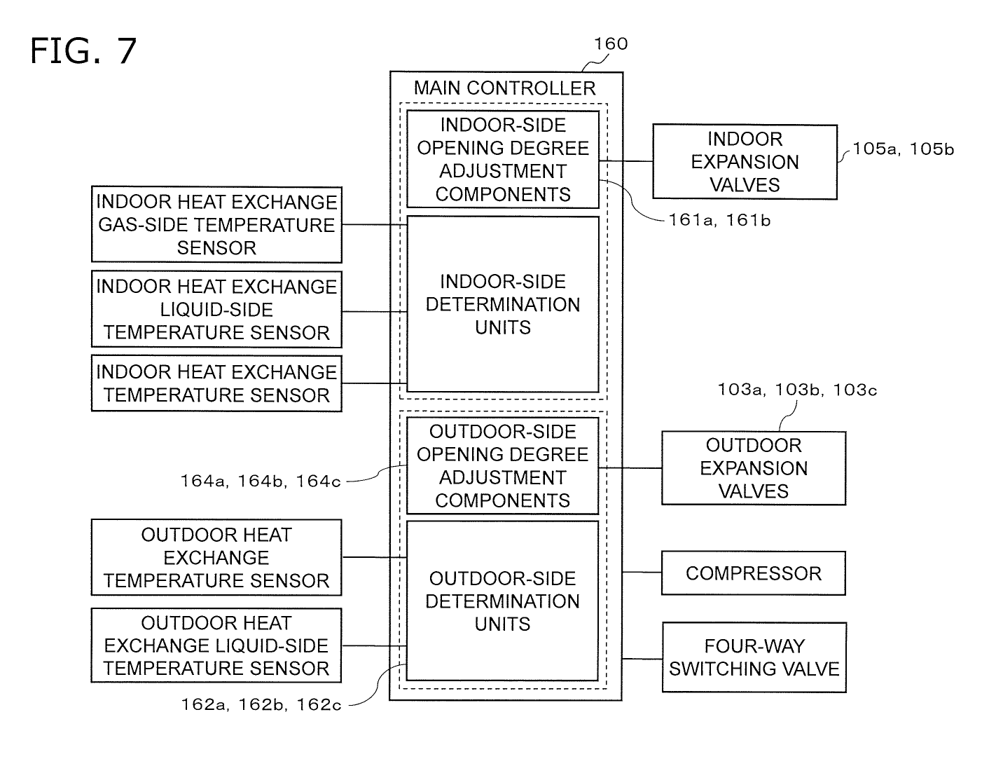

The refrigerant-charging operation mode in the air-conditioning apparatus 200 is described hereinbelow using FIGS. 6, 7, 8, 9, and 10.

In the present embodiment, an example is described in which, similar to the embodiment described above, the first indoor unit 102a, the second indoor unit 102b, and the first outdoor unit 101a, the second outdoor unit 101b, and the third outdoor unit 101c charged in advance with predetermined amounts of refrigerant are installed at an installation site, and the liquid refrigerant communication pipe 111 and the gas refrigerant communication pipe 112 are connected, constituting a refrigerant circuit 110. An additional amount of refrigerant, which is needed according to the lengths of the liquid refrigerant communication pipe 111 and the gas refrigerant communication pipe 112, is then charged into the refrigerant circuit 110. In the refrigerant charging operation described hereinafter, steps S31 through S33 are hereinbelow referred to as the refrigerant-charging initiation operation, steps S34 through S41 are referred to as the refrigerant stabilizing operation, and steps S42 through S47 are referred to as the refrigerant-charging completion operation.

First, an operator performing the refrigerant charging opens a first liquid-side shutoff valve 124a, a second liquid-side shutoff valve 124b, and a third liquid-side shutoff valve 124c, as well as a first gas-side shutoff valve 125a, a second gas-side shutoff valve 125b, and a third gas-side shutoff valve 125c of the first outdoor unit 101a, the second outdoor unit 101b, and the third outdoor unit 101c respectively; and fills the refrigerant circuit 110 with the refrigerant that had been charged in advance into the first outdoor unit 101a, the second outdoor unit 101b, and the third outdoor unit 101c.

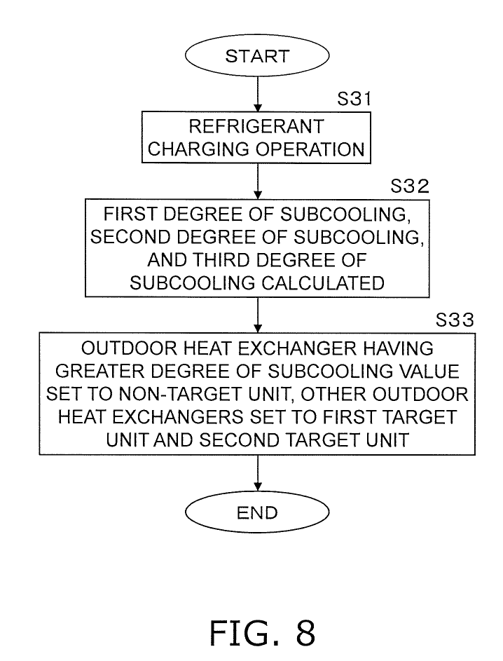

Next, the operator performing the refrigerant charging connects a charge port installed near the first gas-side shutoff valve 125a with a cylinder (not shown) in which refrigerant is sealed, using a charging pipe provided with a charging valve. When the operator performing the refrigerant charging then issues a refrigerant charging operation command to initiate the refrigerant charging, either directly to a main controller 160 or remotely via a remote controller or the like, the process of step S31 shown in FIG. 8 is performed by the main controller 160.

When an initiation command for the refrigerant charging operation is issued, a first four-way switching valve 107a, a second four-way switching valve 107b, and a third four-way switching valve 107c in the first outdoor unit 101a, the second outdoor unit 101b, and the third outdoor unit 101c are set to the state shown by the solid lines in FIG. 6; a first outdoor expansion valve 103a, a second outdoor expansion valve 103b, and a third outdoor expansion valve 103c are all set to an open state; and a first indoor expansion valve 105a and a second indoor expansion valve 105b of the first indoor unit 102a and the second indoor unit 102b are both set to an open state. When a first compressor 108a, a second compressor 108b, and a third compressor 108c are started up during this state of the refrigerant circuit 110, this forces the cooling operation to be performed. The refrigerant already charged into the refrigerant circuit 110 can be stabilized by performing the cooling operation for a predetermined amount of time. After a predetermined amount of time has elapsed since the performing of the cooling operation, the charging valve is set to an open state while the cooling operation continues to be performed, and refrigerant is supplied from the cylinder into the refrigerant circuit 110. The refrigerant charging operation is thereby initiated.

In the refrigerant circuit 110 at this time, high-pressure gas refrigerant compressed in the first compressor 108a, the second compressor 108b, and the third compressor 108c and discharged then flows through the flow passages running from the first compressor 108a, the second compressor 108b, and the third compressor 108c to a first outdoor heat exchanger 104a, a second outdoor heat exchanger 104b, and a third outdoor heat exchanger 104c functioning as condensers; high-pressure refrigerant changing from a gas phase state to a liquid phase state through heat exchange with outdoor air flows into the first outdoor heat exchanger 104a, the second outdoor heat exchanger 104b, and the third outdoor heat exchanger 104c functioning as condensers; high-pressure liquid refrigerant flows through flow passages running from the first outdoor heat exchanger 104a, the second outdoor heat exchanger 104b, and the third outdoor heat exchanger 104c to the first indoor expansion valve 105a and the second indoor expansion valve 105b, which includes the liquid refrigerant communication pipe 111 via the first outdoor expansion valve 103a, the second outdoor expansion valve 103b, and the third outdoor expansion valve 103c; low-pressure refrigerant changing from a gas-liquid two-phase state to a gas phase state through heat exchange with indoor air flows into a first indoor heat exchanger 106a and a second indoor heat exchanger 106b functioning as evaporators; and low-pressure gas refrigerant flows through flow passages running from the first indoor heat exchanger 106a and the second indoor heat exchanger 106b to the first compressor 108a, the second compressor 108b, and the third compressor 108c including the gas refrigerant communication pipe 112. At this time, each of indoor-side opening degree adjustment components 161a, 161b adjust the respective opening degrees of the first indoor expansion valve 105a and the second indoor expansion valve 105b so that each of the degrees of superheat of the refrigerant in the gas sides of the first indoor heat exchanger 106a and the second indoor heat exchanger 106b functioning as evaporators reach a predetermined value. A first outdoor-side determination unit 162a calculates a first degree of subcooling as the subcooling degree of the refrigerant in the liquid side of the first outdoor heat exchanger 104a functioning as a condenser, a second outdoor-side determination unit 162b calculates a second degree of subcooling as the subcooling degree of the refrigerant in the liquid side of the second outdoor heat exchanger 104b, and a third outdoor-side determination unit 162c calculates a third degree of subcooling as the subcooling degree of the refrigerant in the liquid side of the third outdoor heat exchanger 104c (step S32).

The outdoor unit set as the non-target unit is the outdoor unit having the outdoor heat exchanger whose degree of subcooling is calculated to be the greatest of the first degree of subcooling, the second degree of subcooling, and the third degree of subcooling calculated in the first outdoor-side determination unit 162a, the second outdoor-side determination unit 162b, and the third outdoor-side determination unit 162c, and the other outdoor units are set as the first target unit and the second target unit (step S33). The refrigerant-charging initiation operation is thereby completed.

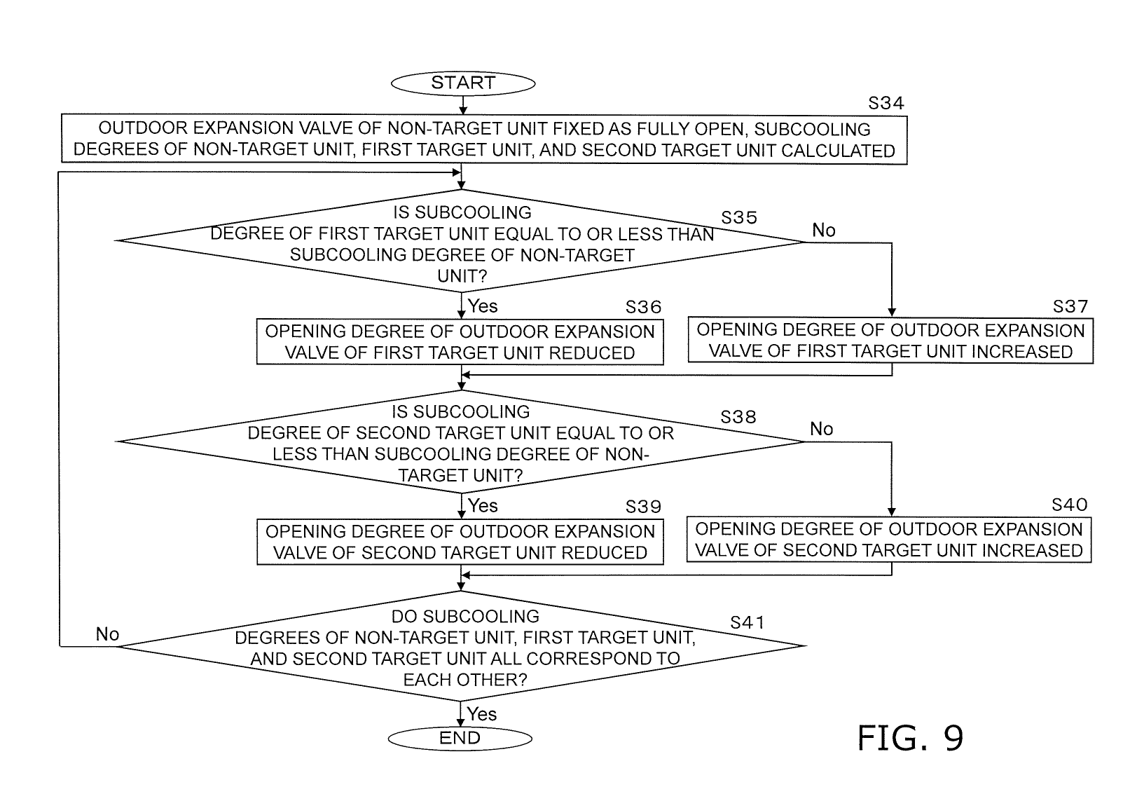

When the refrigerant charging operation is completed, the opening degree of the outdoor expansion valve of the non-target unit is fixed in a fully open state, and the degrees of subcooling of the non-target unit, the first target unit, and the second target unit are recalculated respectively, as shown in FIG. 9 (step S34). The recalculated subcooling degree of the first target unit and the recalculated subcooling degree of the non-target unit are compared (step S35). In cases in which the subcooling degree of the first target unit is equal to or less than the subcooling degree of the non-target unit, the opening degree of the outdoor expansion valve of the first target unit is reduced (step S36). In cases in which the subcooling degree of the first target unit is greater than the subcooling degree of the non-target unit, the opening degree of the outdoor expansion valve of the first target unit is increased (step S37). After the opening degree of the outdoor expansion valve of the first target unit has been adjusted, the subcooling degree of the second target unit and the subcooling degree of the non-target unit calculated in step S34 are compared (step S38). In cases in which the subcooling degree of the second target unit is equal to or less than the subcooling degree of the non-target unit, the opening degree of the outdoor expansion valve of the second target unit is reduced (step S39). In cases in which the subcooling degree of the second target unit is greater than the subcooling degree of the non-target unit, the opening degree of the outdoor expansion valve of the second target unit is increased (step S40). After the opening degrees of each of the outdoor expansion valves of the first target unit and the second target unit have been adjusted, the subcooling degree of the non-target unit, the subcooling degree of the first target unit, and the subcooling degree of the second target unit are recalculated, and a determination is made as to whether or not the degrees of subcooling correspond to each other (step S41). At this time, in cases in which the degrees of subcooling correspond respectively, the refrigerant stabilizing operation is completed (step S8). In cases in which the degrees of subcooling do not correspond to each other, the process moves to step S35, and the degrees of subcooling of the first target unit and the non-target unit are compared again. Note that this refrigerant stabilizing operation is performed in parallel with the refrigerant-charging completion operation which is described hereinbelow.

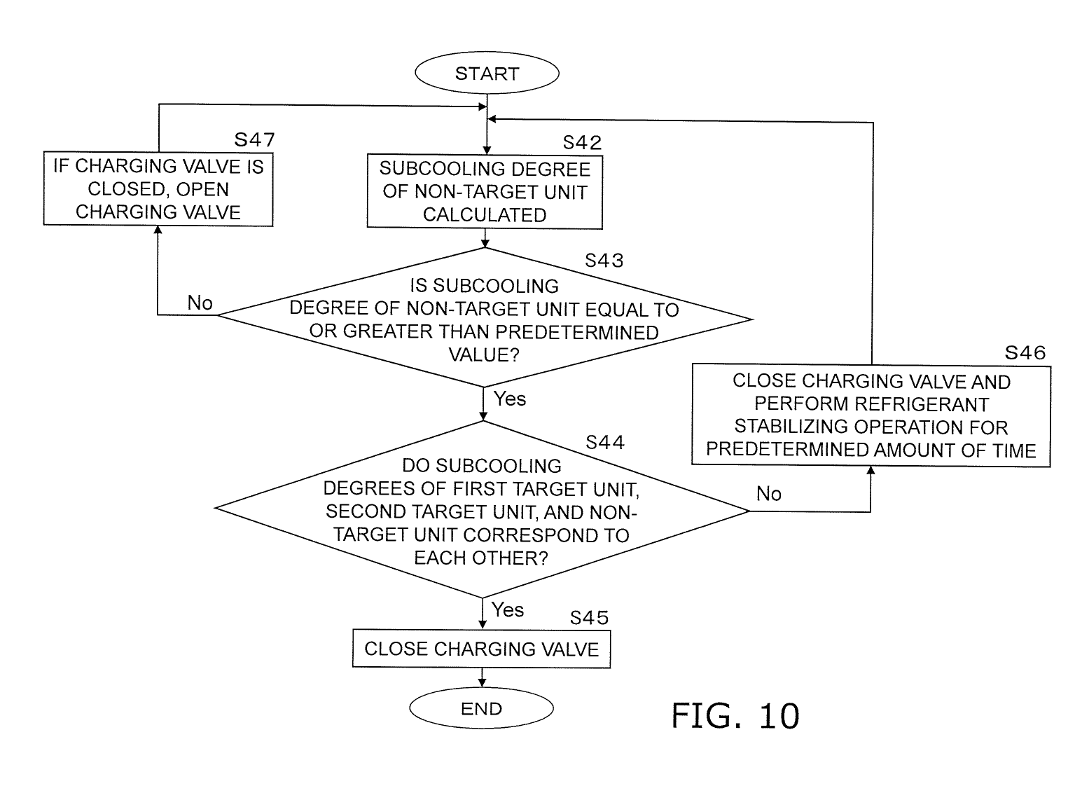

After the refrigerant stabilizing operation has been performed for a predetermined amount of time, the subcooling degree of the non-target unit is recalculated as shown in FIG. 10 (step S42). A comparison is made between the subcooling degree of the non-target unit calculated at this time and a predetermined value set as a target value for refrigerant charging completion (step S43). In cases in which the subcooling degree of the non-target unit at this time is equal to or greater than the predetermined value, the subcooling degree of the non-target unit and the subcooling degrees of the first target unit and the second target unit are compared respectively (step S44). In cases in which the compared degrees of subcooling correspond to each other, the charging valve is set to a closed state, and the supply of refrigerant from the cylinder is stopped (step S45). The refrigerant-charging completion operation is thereby completed. Therefore, the refrigerant charging operation is completed. When the degree of subcooling of the non-target unit is equal to or greater than the predetermined value and the subcooling degree of the non-target unit and the subcooling degrees of the first target unit and the second target unit are compared, the charging valve is set to the closed state and the supply of refrigerant from the cylinder is stopped also in cases in which the degrees of subcooling do not correspond to each other. The refrigerant stabilizing operation is then performed for a predetermined amount of time in a state in which the supply of refrigerant from the cylinder has been stopped (step S46). After the refrigerant stabilizing operation has been performed for a predetermined amount of time, the process moves to step S42, the degree of subcooling of the non-target unit is calculated, and a comparison is made between the non-target unit and the predetermined value (step S43). At this time, in cases in which the degree of subcooling of the non-target unit is not equal to or greater than the predetermined value, the charging valve is set to an open state and the supply of refrigerant from the cylinder is restarted (step S47). Note that in the present embodiment, step S41 and step S44 are performed until the degrees of subcooling of the non-target unit, the first target unit, and the second target unit correspond respectively, but these steps may also be performed until all degrees of subcooling enter a predetermined range.

(B)

In the embodiment described above, the outdoor-side controllers 68a, 68b determine the amount of refrigerant charged into the refrigerant circuit 10 by comparing the degree of subcooling of the non-target unit and a predetermined value. However, in this air-conditioning apparatus 100, the refrigerant stabilizing operation, which is an operation for minimizing drift in the outdoor heat exchangers 4a, 4b, is performed in parallel with the refrigerant-charging completion operation in which the amount of refrigerant charged into the refrigerant circuit 10 is determined. Therefore, the degree of subcooling of the target unit and the degree of subcooling of the non-target unit come to be equal. Consequently, the amount of refrigerant charged into the refrigerant circuit 10 may be determined by comparing the degree of subcooling of the target unit and the predetermined value.

(C)

In the embodiment described above, the opening degrees of the first outdoor expansion valve 3a and the second outdoor expansion valve 3b are adjusted based on the first degree of subcooling and the second degree of subcooling, so that the degree of subcooling of the target unit and the degree of subcooling of the non-target unit come to be equal.

Alternatively, the rotational speed of the first compressor 8a of the first outdoor unit 1a and the rotational speed of the second compressor 8b of the second outdoor unit 1b may be adjusted based on the first degree of subcooling and the second degree of subcooling so that the degree of subcooling of the target unit and the degree of subcooling of the non-target unit come to be equal. The following is a description of the operation of an air-conditioning apparatus wherein the rotational speed of the first compressor 8a and the rotational speed of the second compressor 8b are adjusted so as to reduce the difference between the degree of subcooling of the target unit and the degree of subcooling of the non-target unit during the refrigerant stabilizing operation. Note that the refrigerant-charging initiation operation and the refrigerant-charging completion operation are the same as in the embodiment described above and are therefore not described.

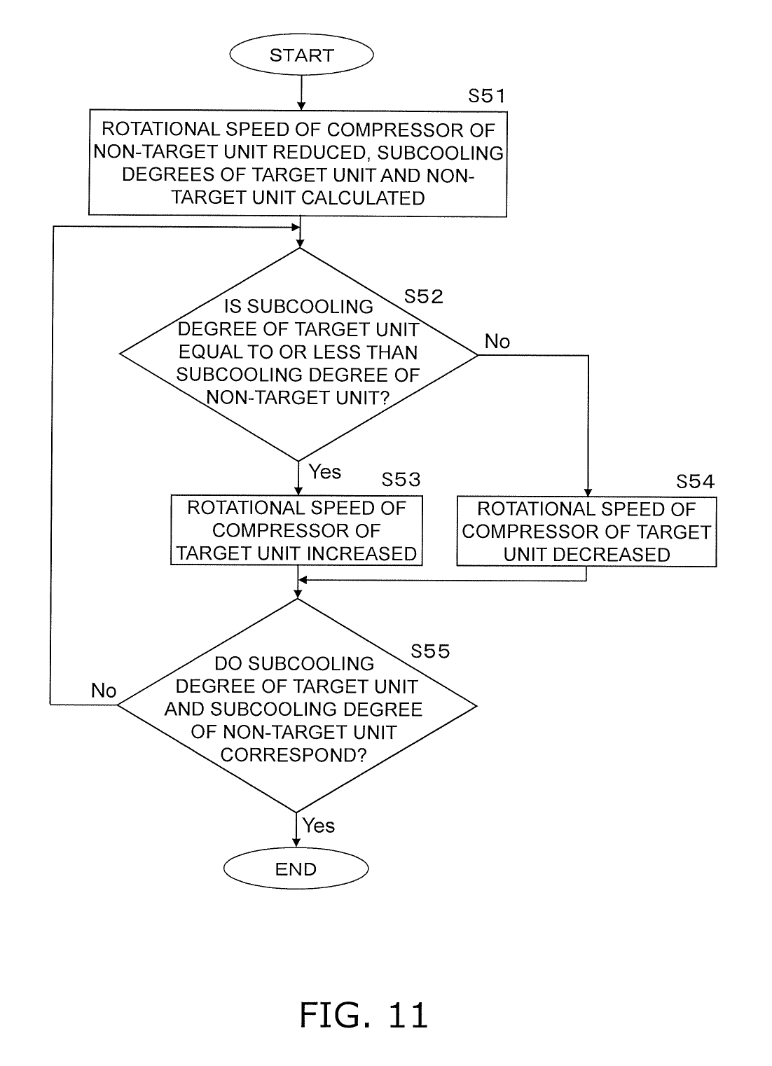

When the refrigerant-charging initiation operation (step S1 through step S3 in FIG. 3) is completed, the rotational speed of the compressor of the non-target unit is decreased, and the degrees of subcooling of the target unit and non-target unit are recalculated respectively as shown in FIG. 11 (step S51). The recalculated degree of subcooling of the target unit and the recalculated degree of subcooling of the non-target unit are then compared (step S52). In cases in which the degree of subcooling of the target unit is equal to or less than the degree of subcooling of the non-target unit, the rotational speed of the compressor of the target unit is increased (step S53). In cases in which the degree of subcooling of the target unit is greater than the degree of subcooling of the non-target unit, the rotational speed of the compressor of the target unit is reduced (step S54). After the rotational speed of the compressor of the target unit has been adjusted, the degree of subcooling of the target unit and the degree of subcooling of the non-target unit are recalculated, and the two degrees of subcooling are compared (step S55). In cases in which the degrees of subcooling correspond to each other at this time, the refrigerant stabilizing operation is completed. In cases in which the degrees of subcooling do not correspond to each other, the process moves to step S52, and the degrees of subcooling of the target unit and non-target unit are compared. Note that the refrigerant stabilizing operation is performed in parallel with the refrigerant-charging completion operation (step S9 through step S14 in FIG. 5).

Performing the refrigerant stabilizing operation in this manner makes it possible to reduce the difference between the flow rate of refrigerant flowing through the outdoor heat exchanger of the target unit and the flow rate of refrigerant in the outdoor heat exchanger of the non-target unit. Therefore, it is possible to inhibit refrigerant drift in the outdoor heat exchanger of the target unit and the outdoor heat exchanger of the non-target unit.

It is thereby possible to improve the precision of determining the amount of refrigerant charged into the refrigerant circuit when refrigerant is charged into the refrigerant circuit.

The rotational speed of the first outdoor fan 9a of the first outdoor unit 1a and the rotational speed of the second outdoor fan 9b of the second outdoor unit 1b may also be adjusted based on the first degree of subcooling and the second degree of subcooling, so that the degree of subcooling of the target unit and the degree of subcooling of the non-target unit come to be equal. The following is a description of the operation of an air-conditioning apparatus wherein the rotational speed of the first outdoor fan 9a and the rotational speed of the second outdoor fan 9b are adjusted in order to reduce the difference between the degree of subcooling of the target unit and the degree of subcooling of the non-target unit in the refrigerant stabilizing operation. Note that the refrigerant-charging initiation operation and the refrigerant-charging completion operation are the same as in the embodiment described above and are therefore not described.

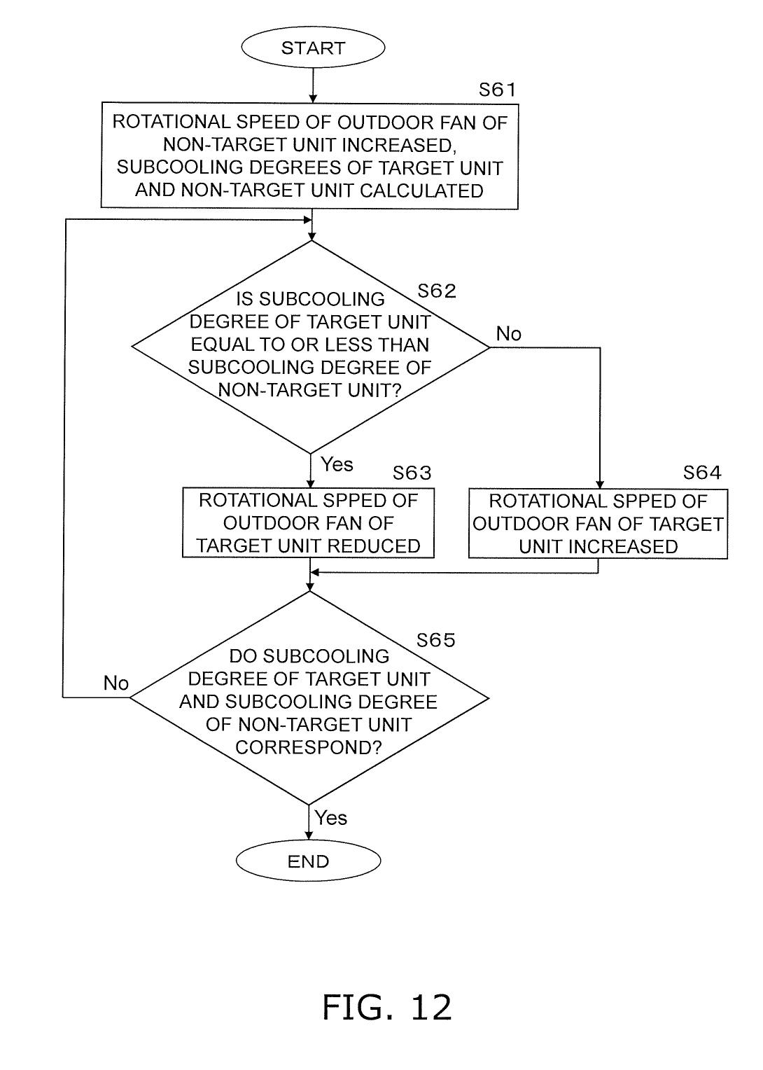

When the refrigerant-charging initiation operation (step S1 through step S3 in FIG. 3) is completed, the rotational speed of the outdoor fan of the non-target unit is increased, and each of the degrees of subcooling of the target unit and non-target unit are recalculated as shown in FIG. 12 (step S61). The recalculated degree of subcooling of the target unit and the recalculated degree of subcooling of the non-target unit are then compared (step S62). In cases in which the degree of subcooling of the target unit is equal to or less than the degree of subcooling of the non-target unit, the rotational speed of the outdoor fan of the target unit is reduced (step S63). In cases in which the degree of subcooling of the target unit is greater than the degree of subcooling of the non-target unit, the rotational speed of the outdoor fan of the target unit is increased (step S64). After the rotational speed of the outdoor fan of the target unit has been adjusted, the degree of subcooling of the target unit and the degree of subcooling of the non-target unit are recalculated, and the two degrees of subcooling are compared (step S65). In cases in which the degrees of subcooling correspond respectively at this time, the refrigerant stabilizing operation is completed. In cases in which the degrees of subcooling do not correspond respectively, the process moves to step S62, and the degrees of subcooling of the target unit and the non-target unit are compared. Note that this refrigerant stabilizing operation is performed in parallel with the refrigerant-charging completion operation (step S9 through step S14 in FIG. 5).

Performing the refrigerant stabilizing operation in this manner makes it possible to reduce the difference between the degree of subcooling of the target unit and the degree of subcooling of the non-target unit.

It is thereby possible to improve the precision of determining the amount of refrigerant charged into the refrigerant circuit when refrigerant is charged into the refrigerant circuit.

In the refrigerant stabilizing operation, any means from a group consisting of compressor adjustment means for adjusting the rotational speed of the compressors, expansion valve adjustment means for adjusting the opening degrees of the outdoor expansion valves, and fan adjustment means for adjusting the rotational speeds of the outdoor fans may be combined and controlled so that the degree of subcooling of the target unit and the degree of subcooling of the non-target unit come to be equal.

### INDUSTRIAL APPLICABILITY

According to the present invention, it is possible to improve the precision of determining the amount of refrigerant charged into the refrigerant circuit when refrigerant is charged into the refrigerant circuit, and the present invention is therefore effectively applied to an air-conditioning apparatus comprising a plurality of heat source units.

1. An air-conditioning apparatus comprising:
a first heat source unit having a first heat source-side heat exchanger and a first heat source-side degree of subcooling adjustment device configured to adjust a first degree of subcooling in an outlet side of the first heat source-side heat exchanger, the first heat source-side heat exchanger being operable at least as a condenser;
a second heat source unit having a second heat source-side heat exchanger and a second heat source-side degree of subcooling adjustment device configured to adjust a second degree of subcooling in an outlet side of the second heat source-side heat exchanger, the second heat source-side heat exchanger being operable at least as a condenser;
a first determination unit configured to determine the first degree of subcooling;
a second determination unit configured to determine the second degree of subcooling; and
a controller configured to control the first heat source-side degree of subcooling adjustment device and the second heat source-side degree of subcooling adjustment device such that a difference between the first degree of subcooling and the second degree of subcooling is reduced when refrigerant is charged into a refrigerant circuit having the first and second heat source-side heat exchangers.

2. The air-conditioning apparatus according to claim 1, further comprising:
a first temperature sensor configured to detect temperature of refrigerant in the first heat source unit; and
a second temperature sensor configured to detect temperature of refrigerant in the second heat source unit,
the first determination unit being configured to determine the first degree of subcooling based on the temperature detected by the first temperature sensor, and
the second determination unit being configured to determine the second degree of subcooling based on the temperature detected by the second temperature sensor.

3. The air-conditioning apparatus according to claim 1, wherein
the first heat source-side degree of subcooling adjustment device includes a first heat source-side flow rate adjustment valve;
the second heat source-side degree of subcooling adjustment device includes a second heat source-side flow rate adjustment valve; and
the controller is further configured to
set the first heat source-side flow rate adjustment valve to a first opening degree, and
set the opening degree of the second heat source-side flow rate adjustment valve to a second opening degree having a smaller opening than the first opening degree when the first degree of subcooling is greater than the second degree of subcooling.

4. The air-conditioning apparatus according to claim 1, wherein
the controller is further configured to determine an amount of refrigerant in the refrigerant circuit based on either the first degree of subcooling or the second degree of subcooling.

5. The air-conditioning apparatus according to claim 1, further comprising:
a usage unit having a usage-side heat exchanger and a usage-side flow rate adjustment mechanism configured to adjust the flow rate of refrigerant flowing through the usage-side heat exchanger, the usage-side heat exchanger being operable at least as an evaporator,
the usage-side heat exchanger and the usage-side flow rate adjustment mechanism being parts of the refrigerant circuit, and
the controller is further configured to control the usage-side flow rate adjustment mechanism such that a degree of superheat in an outlet side of the usage-side heat exchanger reaches a predetermined value when refrigerant is charged into the refrigerant circuit.

6. An air-conditioning apparatus comprising:
first through n-th heat source units having first through n-th heat source-side heat exchangers and first through n-th heat source-side flow rate adjustment devices configured to adjust flow rate of refrigerant flowing through the first through n-th heat source-side heat exchangers, the first through n-th heat source-side heat exchangers being operable at least as a condensers;
first through n-th determination units configured to determine first through n-th degrees of subcooling in sides of the first through n-th heat source-side heat exchangers, respectively; and
a controller configured to control the first through n-th heat source-side flow rate adjustment devices such that the first through n-th degrees of subcooling become equal when refrigerant is charged into a refrigerant circuit having the first through n-th heat source-side heat exchangers and the first through n-th heat source-side flow rate adjustment devices.

7. The air-conditioning apparatus according to claim 6, wherein
the first through n-th heat source-side flow rate adjustment devices include first through n-th heat source-side flow rate adjustment valves, respectively; and
the controller is further configured to
set the first heat source-side flow rate adjustment valve to a first opening degree, and
set the opening degrees of the second through n-th heat source-side flow rate adjustment valves to opening degrees having smaller openings than the first opening degree when the first degree of subcooling is greater than any of the second through n-th degrees of subcooling.

8. The air-conditioning apparatus according to claim 1, wherein
the first heat source-side degree of subcooling adjustment device includes a first compressor configured to compress refrigerant flowing through the refrigerant circuit;
the second heat source-side degree of subcooling adjustment device includes a second compressor configured to compress refrigerant flowing through the refrigerant circuit; and
the controller is further configured to control the first compressor and the second compressor such that a rotational speed of the first compressor is less than a rotational speed of the second compressor when the first degree of subcooling is greater than the second degree of subcooling.

9. The air-conditioning apparatus according to claim 1, wherein
the first heat source-side degree of subcooling adjustment device includes a first heat source-side fan configured to blow air to the first heat source-side heat exchanger;
the second heat source-side degree of subcooling adjustment device includes a second heat source-side fan configured to blow air to the second heat source-side heat exchanger; and
the controller is further configured to control the first heat source-side fan and the second heat source-side fan such that a rotational speed of the first heat source-side fan is greater than a rotational speed of the second heat source-side fan when the first degree of subcooling is greater than the second degree of subcooling.

10. The air-conditioning apparatus according to claim 2, wherein
the first heat source-side degree of subcooling adjustment device includes a first heat source-side flow rate adjustment valve;
the second heat source-side degree of subcooling adjustment device includes a second heat source-side flow rate adjustment valve; and
the controller is further configured to
set the first heat source-side flow rate adjustment valve to a first opening degree, and
set the opening degree of the second heat source-side flow rate adjustment valve to a second opening degree having a smaller opening than the first opening degree when the first degree of subcooling is greater than the second degree of subcooling.

11. The air-conditioning apparatus according to claim 10, wherein
the controller is further configured to determine an amount of refrigerant in the refrigerant circuit based on either the first degree of subcooling or the second degree of subcooling.

12. The air-conditioning apparatus according to claim 11, further comprising:
a usage unit having a usage-side heat exchanger and a usage-side flow rate adjustment mechanism configured to adjust the flow rate of refrigerant flowing through the usage-side heat exchanger, the usage-side heat exchanger being operable at least as an evaporator,
the usage-side heat exchanger and the usage-side flow rate adjustment mechanism being parts of the refrigerant circuit, and
the controller is further configured to control the usage-side flow rate adjustment mechanism such that a degree of superheat in an outlet side of the usage-side heat exchanger reaches a predetermined value when refrigerant is charged into the refrigerant circuit.

13. The air-conditioning apparatus according to claim 2, wherein
the controller is further configured to determine an amount of refrigerant in the refrigerant circuit based on either the first degree of subcooling or the second degree of subcooling.

15. The air-conditioning apparatus according to claim 2, further comprising:
a usage unit having a usage-side heat exchanger and a usage-side flow rate adjustment mechanism configured to adjust the flow rate of refrigerant flowing through the usage-side heat exchanger, the usage-side heat exchanger being operable at least as an evaporator,
the usage-side heat exchanger and the usage-side flow rate adjustment mechanism being parts of the refrigerant circuit, and
the controller is further configured to control the usage-side flow rate adjustment mechanism such that a degree of superheat in an outlet side of the usage-side heat exchanger reaches a predetermined value when refrigerant is charged into the refrigerant circuit.

15. The air-conditioning apparatus according to claim 2, wherein
the first heat source-side degree of subcooling adjustment device includes a first compressor configured to compress refrigerant flowing through the refrigerant circuit;
the second heat source-side degree of subcooling adjustment device includes a second compressor configured to compress refrigerant flowing through the refrigerant circuit; and
the controller is further configured to control the first compressor and the second compressor such that a rotational speed of the first compressor is less than a rotational speed of the second compressor when the first degree of subcooling is greater than the second degree of subcooling.

16. The air-conditioning apparatus according to claim 2, wherein
the first heat source-side degree of subcooling adjustment device includes a first heat source-side fan configured to blow air to the first heat source-side heat exchanger;
the second heat source-side degree of subcooling adjustment device includes a second heat source-side fan configured to blow air to the second heat source-side heat exchanger; and
the controller is further configured to control the first heat source-side fan and the second heat source-side fan such that a rotational speed of the first heat source-side fan is greater than a rotational speed of the second heat source-side fan when the first degree of subcooling is greater than the second degree of subcooling.

17. The air-conditioning apparatus according to claim 3, wherein
the controller is further configured to determine an amount of refrigerant in the refrigerant circuit based on either the first degree of subcooling or the second degree of subcooling.

18. The air-conditioning apparatus according to claim 17, further comprising:
a usage unit having a usage-side heat exchanger and a usage-side flow rate adjustment mechanism configured to adjust the flow rate of refrigerant flowing through the usage-side heat exchanger, the usage-side heat exchanger being operable at least as an evaporator,
the usage-side heat exchanger and the usage-side flow rate adjustment mechanism being parts of the refrigerant circuit, and
the controller is further configured to control the usage-side flow rate adjustment mechanism such that a degree of superheat in an outlet side of the usage-side heat exchanger reaches a predetermined value when refrigerant is charged into the refrigerant circuit.

19. The air-conditioning apparatus according to claim 3, further comprising:
a usage unit having a usage-side heat exchanger and a usage-side flow rate adjustment mechanism configured to adjust the flow rate of refrigerant flowing through the usage-side heat exchanger, the usage-side heat exchanger being operable at least as an evaporator,
the usage-side heat exchanger and the usage-side flow rate adjustment mechanism being parts of the refrigerant circuit, and
the controller is further configured to control the usage-side flow rate adjustment mechanism such that a degree of superheat in an outlet side of the usage-side heat exchanger reaches a predetermined value when refrigerant is charged into the refrigerant circuit.

20. The air-conditioning apparatus according to claim 4, further comprising:
a usage unit having a usage-side heat exchanger and a usage-side flow rate adjustment mechanism configured to adjust the flow rate of refrigerant flowing through the usage-side heat exchanger, the usage-side heat exchanger being operable at least as an evaporator,
the usage-side heat exchanger and the usage-side flow rate adjustment mechanism being parts of the refrigerant circuit, and
the controller is further configured to control the usage-side flow rate adjustment mechanism such that a degree of superheat in an outlet side of the usage-side heat exchanger reaches a predetermined value when refrigerant is charged into the refrigerant circuit.
